(19) United States
(12) Patent Application Publication
(10) Pub. No.: US 2026/0073631 A1
(43) Pub. Date: Mar. 12, 2026

(54) SYSTEMS AND METHODS FOR ENVIRONMENT MAPPING BASED ON MULTI-DOMAIN SENSOR DATA

(71) Applicant: QUALCOMM Incorporated, San Diego, CA (US)

(72) Inventors: Changhong YANG, Chengdu (CN); Zhixun XIA, Chengdu (CN); Nan JIA, Chengdu (CN); Linkun XU, Chengdu (CN)

(21) Appl. No.: 19/128,156

(22) PCT Filed: Feb. 2, 2023
(86) PCT No.: PCT/CN2023/074204

§ 371 Date: May 7, 2025

(51) Int. Cl. G06T 17/05; B60W 60/00; G01C 21/00; G06T 7/13; G06T 7/50; G06T 15/08; G06V 10/26; G06V 20/56

(52) U.S. Cl. CPC G06T 17/05; G01C 21/3837; G06T 7/13; G06T 7/50; G06T 15/08; G06V 10/26; B60W 60/00; B60W 2420/403; G06T 2207/10028; G06T 2207/30252; G06V 20/56

(57) ABSTRACT

Systems and techniques for environment mapping are described. In some examples, a system receives image data and depth data captured using at least one sensor. The image data and the depth data both include respective representations of an environment. The system processes the image data using semantic segmentation to identify segments of the environment that represent different types of objects in the environment in the image data. The system combines the depth data with the semantic segmentation to generate a voxel-based three-dimensional map of the environment.

### FIELD

The present disclosure generally relates to imaging and environment mapping. For example, aspects of the present disclosure relate to systems and techniques for voxel-based mapping of an environment based on image data and depth data.

### BACKGROUND

A camera is a device that includes an image sensor that receives light from a scene and captures image data, such as still images or video frames of a video, depicting the scene. A depth sensor is a sensor that obtains depth data indicating how far different points in a scene are from the depth sensor. The depth data can include a depth map, a depth image, a point cloud, or another indication of depth, range, and/or distance. A depth sensor can also be referred to as a range sensor or a distance sensor. Depth sensors can have limitations in the depth data they obtain. For instance, depth data captured by depth sensors can identify depths of points along edges of a surface in a scene without identifying depths for other portions of the surface between the edges.

### BRIEF SUMMARY

Systems and techniques are described herein for environment mapping. According to aspects described herein, the systems and techniques can perform environment mapping based on a combination of image data and depth data. In some examples, a system receives image data and depth data captured using at least one sensor. The image data and the depth data both include respective representations of an environment. The system processes the image data using semantic segmentation to identify segments of the environment that represent different types of objects in the environment in the image data. The system combines the depth data with the semantic segmentation to generate a voxel-based three-dimensional map of the environment.

According to at least one example, an apparatus for environment mapping is provided. The apparatus includes a memory and at least one processor (e.g., implemented in circuitry) coupled to the memory. The at least one processor is configured to and can: receive image data and depth data captured using at least one sensor, the image data and the depth data including respective representations of an environment; process the image data using semantic segmentation to generate segmented image data that identifies a plurality of segments of the environment, wherein the plurality of segments represent different types of objects in the environment; and combine the depth data with the segmented image data to generate a voxel-based three-dimensional map of the environment.

In another example, a method of environment mapping is provided. The method includes: receiving image data and depth data captured using at least one sensor, the image data and the depth data including respective representations of an environment; processing the image data using semantic segmentation to generate segmented image data that identifies a plurality of segments of the environment, wherein the plurality of segments represent different types of objects in the environment; and combining the depth data with the segmented image data to generate a voxel-based three-dimensional map of the environment.

In another example, a non-transitory computer-readable medium is provided that has stored thereon instructions that, when executed by one or more processors, cause the one or more processors to: receive image data and depth data captured using at least one sensor, the image data and the depth data including respective representations of an environment; process the image data using semantic segmentation to generate segmented image data that identifies a plurality of segments of the environment, wherein the plurality of segments represent different types of objects in the environment; and combine the depth data with the segmented image data to generate a voxel-based three-dimensional map of the environment.

In another example, an apparatus for environment mapping is provided. The apparatus includes: means for receiving image data and depth data captured using at least one sensor, the image data and the depth data including respective representations of an environment; means for processing the image data using semantic segmentation to generate segmented image data that identifies a plurality of segments of the environment, wherein the plurality of segments represent different types of objects in the environment; and means for combining the depth data with the segmented image data to generate a voxel-based three-dimensional map of the environment.

In some aspects, one or more of the methods, apparatuses, and computer-readable medium described above further comprise: omitting at least one point from a point cloud from the voxel-based three-dimensional map of the environment based on the segmented image data, wherein the depth data includes the point cloud with a plurality of points. In some aspects, one or more of the methods, apparatuses, and computer-readable medium described above further comprise: adding at least one voxel to the voxel-based three-dimensional map of the environment based on the segmented image data despite a lack of a point in a point cloud corresponding to the at least one voxel, wherein the depth data includes the point cloud with a plurality of points. In some aspects, one or more of the methods, apparatuses, and computer-readable medium described above further comprise: adding at least one voxel to the voxel-based three-dimensional map of the environment corresponding to a non-edge portion of an object based on the segmented image data despite a lack of representation of the non-edge portion of the object in the depth data, wherein the depth data identifies an edge of the object of the different types of objects in the environment.

In some aspects, one or more of the methods, apparatuses, and computer-readable medium described above further comprise: identifying a depth of an object in the voxel-based three-dimensional map of the environment based on the depth data; and identifying a shape of the object in the voxel-based three-dimensional map of the environment based on the segmented image data. In some aspects, one or more of the methods, apparatuses, and computer-readable medium described above further comprise: identifying color information corresponding to voxels of the voxel-based three-dimensional map of the environment based on colors of corresponding portions of the environment as represented in the image data.

In some aspects, one or more of the methods, apparatuses, and computer-readable medium described above further comprise: identifying respective confidence levels corresponding to the plurality of segments being identified, using the semantic segmentation, as respectively representing the different types of objects. In some aspects, one or more of the methods, apparatuses, and computer-readable medium described above further comprise: identifying, based on the segmented image data, different voxels of the voxel-based three-dimensional map of the environment as representing the different types of objects. In some aspects, the different types of objects in the environment include at least one of ground, sky, plants, structures, people, and vehicles.

In some aspects, the at least one sensor includes an image sensor, wherein the image sensor is configured to capture at least the image data. In some aspects, depth data is based on the image data from the image sensor. In some aspects, the at least one sensor includes a depth sensor, wherein the depth sensor is configured to capture at least the depth data.

In some aspects, one or more of the methods, apparatuses, and computer-readable medium described above further comprise: outputting an indication of the voxel-based three-dimensional map of the environment. In some aspects, one or more of the methods, apparatuses, and computer-readable medium described above further comprise: causing display of at least a portion of the voxel-based three-dimensional map of the environment using a display. In some aspects, one or more of the methods, apparatuses, and computer-readable medium described above further comprise: causing transmission of at least a portion of the voxel-based three-dimensional map of the environment to a recipient device using a communication interface.

In some aspects, one or more of the methods, apparatuses, and computer-readable medium described above further comprise: generating a route through the environment for a vehicle based on the voxel-based three-dimensional map of the environment. In some aspects, one or more of the methods, apparatuses, and computer-readable medium described above further comprise: modifying movement of a vehicle through the environment based on the voxel-based three-dimensional map of the environment.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of an image capture and processing system, in accordance with some examples;

FIG. 2 is a block diagram illustrating an example architecture of an environment mapping process performed using an environment mapping system, in accordance with some examples;

FIG. 3A is a perspective diagram illustrating a head-mounted display (HMD) that is used as part of an imaging system, in accordance with some examples;

FIG. 3B is a perspective diagram illustrating the head-mounted display (HMD) of FIG. 3A being worn by a user, in accordance with some examples;

FIG. 4A is a perspective diagram illustrating a front surface of a mobile handset that includes front-facing cameras and that can be used as part of an imaging system, in accordance with some examples;

FIG. 4B is a perspective diagram illustrating a rear surface of a mobile handset that includes rear-facing cameras and that can be used as part of an imaging system, in accordance with some examples;

FIG. 5 is a perspective diagram illustrating a vehicle that includes various sensors, in accordance with some examples;

FIG. 6 is a perspective diagram illustrating a first vehicle located in an environment, in accordance with some examples;

FIG. 7 is a perspective diagram illustrating a depth data representing the environment of FIG. 6 as captured using a depth sensor of the first vehicle, in accordance with some examples;

FIG. 8 is a perspective diagram illustrating a voxel-based three-dimensional map representing the environment of FIG. 6 generated using the depth data of FIG. 7 and image data of the environment captured using an image sensor of the first vehicle, in accordance with some examples;

FIG. 9 is a conceptual diagram illustrating probabilities for classification of adjacent voxels, in accordance with some examples;

FIG. 10 is a block diagram illustrating an example of a neural network that can be used for environment mapping, in accordance with some examples;

FIG. 11 is a flow diagram illustrating an environment mapping process, in accordance with some examples; and

FIG. 12 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

A depth sensor is a sensor that obtains depth data indicating how far different points in a scene are from the depth sensor. The depth data can include a depth map, a depth image, a point cloud (e.g., a semi-dense point cloud), or another indication of depth, range, and/or distance. A depth sensor can also be referred to as a range sensor or a distance sensor. Depth sensors can include, for instance, light detection and ranging (LIDAR) sensors, radio detection and ranging (RADAR) sensors, sound detection and ranging (SODAR) sensors, sound navigation and ranging (SONAR) sensors, time of flight (ToF) sensors, structured light sensors, stereoscopic camera systems, stereoscopic image sensor systems, other depth sensors discussed herein, or combinations thereof.

Depth sensors can have limitations in the depth data they obtain. For instance, depth data captured by depth sensors can identify depths of points along edges of a surface in a scene without identifying depths for other portions of the surface between the edges, even if image data depicting the same scene could depict the entire surface.

Environment mapping systems and techniques are described. An environment mapping system receives image data and depth data captured using at least one sensor. The image data and the depth data both include respective representations of an environment. The environment mapping system processes the image data using semantic segmentation to identify segments of the environment that represent different types of objects in the environment in the image data. The environment mapping system combines the depth data with the semantic segmentation to generate a voxel-based three-dimensional map of the environment.

The environment mapping systems and techniques described herein provide a number of technical improvements over prior environment mapping systems. For instance, the environment mapping systems and techniques described herein generate environment maps based on a combination of depth data and image data to provide improved integrity, location precision, shape precision, and semantic precision in environment mapping compared to environment mapping systems that generate environment maps solely based on depth data, or solely based on image data. For instance, because depth data can depths for identify edges of objects without identifying depths for non-edge portions of those objects, environment maps generated solely based on depth data can sometimes incorrectly omit non-edge portions of the objects. By using both depth data and image data (e.g., with semantic segmentation), the environment mapping systems and techniques described herein can use the image data to identify the non-edge portions of the objects corresponding to the edges of the objects, and can thus ensure that objects are fully and correctly represented in the resulting environment maps, without omission of non-edge portions. Generally, depth sensors can also have lower resolutions than image sensors. Thus, environment maps generated solely based on depth data can sometimes inaccurately represent the shapes of certain objects, for instance at the edges of those objects. By using both depth data and image data (e.g., with semantic segmentation), the environment mapping systems and techniques described herein can use the higher resolution of the image data to correct the shapes of certain objects, for instance at the edges of those objects, compared to the lower resolution at which those objects are represented in the depth data.

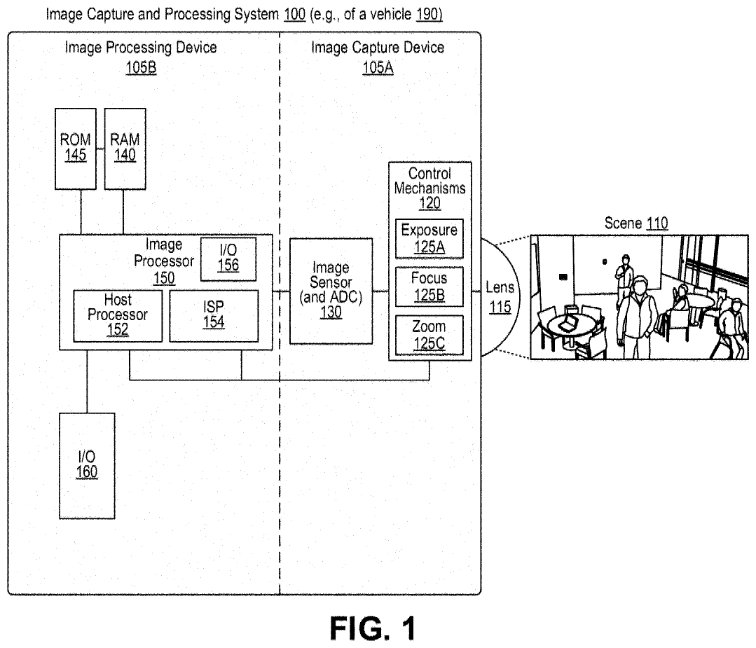

Various aspects of the application will be described with respect to the figures. FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment. In some examples, the image capture and processing system 100 is coupled to, and/or part of, a vehicle 190, and the scene 110 is a scene in an environment around the vehicle 190. In some examples, the scene 110 is a scene of at least a portion of a user. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1210 discussed with respect to the computing system 1200. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 1220, read-only memory (ROM) 145 and/or 1225, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1235, any other input devices 1245, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1202.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

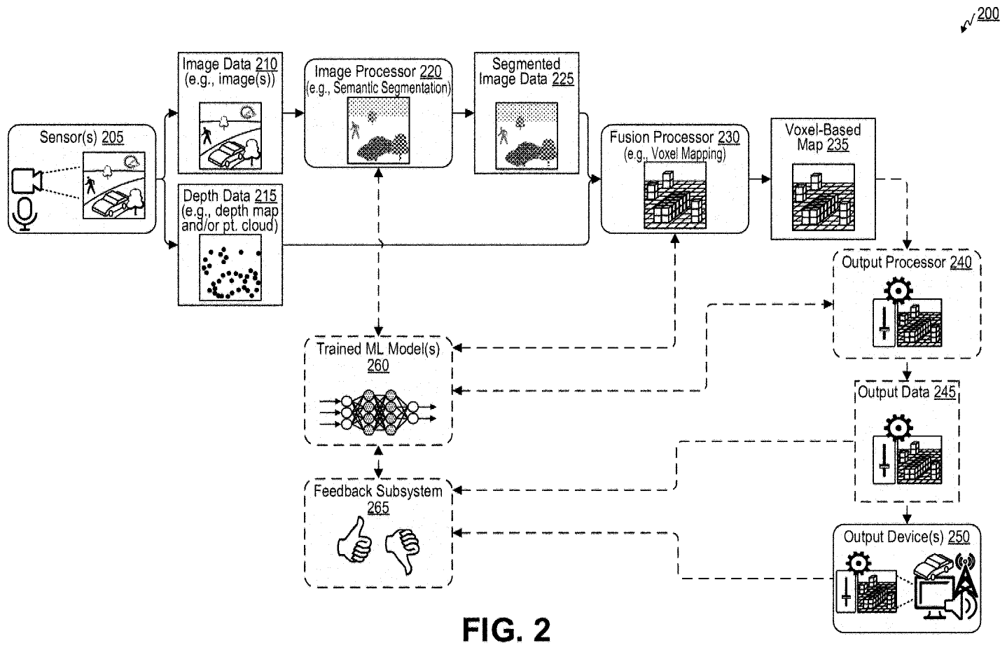

FIG. 2 is a block diagram illustrating an example architecture of an environment mapping process performed using an environment mapping system 200. The environment mapping system 200 can include, or be part of, at least one of the image capture and processing system 100, the image capture device 105A, the image processing device 105B, the vehicle 190, the HMD 310, the mobile handset 410, the vehicle 510, the first vehicle 605, the vehicle computing device 615, the sensors 625, the neural network 1000, the environment mapping system that performs the process 1100, the computing system 1200, the processor 1210, or a combination thereof. In some examples, the environment mapping system 200 can include, or be part of, for instance, one or more laptops, phones, tablet computers, mobile handsets, video game consoles, vehicle computers, vehicles, desktop computers, wearable devices, televisions, media centers, XR systems, head-mounted display (HMD) devices, other types of computing devices discussed herein, or combinations thereof.

The environment mapping system 200 includes one or more sensors 205 configured to capture image data 210 and depth data 215. In some examples, the sensor(s) 205 include one or more image sensors or one or more cameras. In some aspects, the sensor(s) 205 include multiple sensors. In some cases, each sensor of the multiple sensors can be asynchronous with respect to at least one other sensor of the multiple sensors (e.g., a first sensor of the multiple sensors is asynchronous with respect to a second, third, etc. sensor of the multiple sensors), or all of the sensors can be asynchronous with respect to one another. In some cases, at least two of the multiple sensors can be synchronous with respect to each other. In some examples, the frame rate and/or resolution of each sensor of the multiple sensors can be different from at least one other sensor of the multiple sensors, or all of the sensors can have different frame rates and/or resolutions.

In some examples, the image data 210 and/or the depth data 215 captured using the sensor(s) 205 includes raw image data, image data, pixel data, image frame(s), raw video data, video data, video frame(s), or a combination thereof. In some examples, at least one of the sensor(s) 205 can be directed toward a user and/or vehicle (e.g., can face toward the user and/or vehicle), and can thus capture sensor data (e.g., image data) of (e.g., depicting or otherwise representing) at least portion(s) of the user and/or vehicle. In some examples, at least one of the sensor(s) 205 can be directed away from the user and/or vehicle (e.g., can face away from the user and/or vehicle) and/or toward an environment that the user and/or vehicle is in, and can thus capture sensor data (e.g., image data) of (e.g., depicting or otherwise representing) at least portion(s) of the environment. In some examples, sensor data captured by at least one of the sensor(s) 205 that is directed away from the user (and/or vehicle) and/or toward the environment can have a field of view (FoV) that includes, is included by, overlaps with, and/or otherwise corresponds to, a FoV of the eyes of the user (and/or a FoV from a location of the vehicle). Within FIG. 2, a graphic representing the sensor(s) 205 illustrates the sensor(s) 205 as including a camera and a microphone facing an environment with a car driving along a road, two trees on either side of the road, and a pedestrian beside the road, with a bit of the sky in the background. Within FIG. 2, a graphic representing the image data 210 illustrates an image depicting of the environment illustrated in the graphic representing the sensor(s) 205. Within FIG. 2, a graphic representing the depth data 215 illustrates a point cloud with points clustered around edges of objects in the environment illustrated in the graphic representing the sensor(s) 205.

One or more image sensors (e.g., image sensor 130) of the sensor(s) 205 are used to capture the image data 210. In some examples, one or more image sensors (e.g., image sensor 130) of the sensor(s) 205 are used to capture the depth data 215. For instance, one or more of the image sensor(s) of the sensor(s) 205 can be configured to function as time of flight (ToF) sensors or structured light sensors, and/or as part of a stereoscopic camera system. By functioning in this way, the image sensor(s) of the sensor(s) 205 can capture the depth data 215.

In some examples, the sensor(s) 205 can include one or more depth sensors that can capture the depth data 215. The depth data 215 can include a depth map, a depth image, a point cloud (e.g., a sparse point cloud or a semi-dense point cloud), or another indication of depth, range, and/or distance. A depth sensor can also be referred to as a range sensor or a distance sensor. Depth sensors can include, for instance, light detection and ranging (LIDAR) sensors, radio detection and ranging (RADAR) sensors, sound detection and ranging (SODAR) sensors, sound navigation and ranging (SONAR) sensors, time of flight (ToF) sensors, structured light sensors, stereoscopic camera systems, stereoscopic image sensor systems, other depth sensors discussed herein, or combinations thereof.

In some examples, the sensor(s) 205 can include one or more cameras, image sensors, microphones, heart rate monitors, oximeters, biometric sensors, positioning receivers, Global Navigation Satellite System (GNSS) receivers, Inertial Measurement Units (IMUs), accelerometers, gyroscopes, gyrometers, barometers, thermometers, altimeters, depth sensors, light detection and ranging (LIDAR) sensors, radio detection and ranging (RADAR) sensors, sound detection and ranging (SODAR) sensors, sound navigation and ranging (SONAR) sensors, time of flight (ToF) sensors, structured light sensors, other sensors discussed herein, or combinations thereof. In some examples, the one or more sensors 205 include at least one image capture and processing system 100, image capture device 105A, image processing device 105B, or combination(s) thereof. In some examples, the one or more sensors 205 include at least one input device 1245 of the computing system 1200. In some implementations, one or more of the sensor(s) 205 may complement or refine sensor readings from other sensor(s) 205. For example, Inertial Measurement Units (IMUs), accelerometers, gyroscopes, or other sensors may be used to identify a pose (e.g., position and/or orientation) of the environment mapping system 200 and/or of the user in the environment, and/or the gaze of the user through the environment mapping system 200.

The environment mapping system 200 includes an image processor 220 that processes the image data 210 to perform semantic segmentation on the image data 210 to generate segmented image data 225. The image processor 220 can include, for example, the image processing device 105B, the image processor 150, the host processor 152, the ISP 154, the processor 1210, or a combination thereof. To perform semantic segmentation on the image data 210, the image processor 220 classifies and/or categorizes each pixel of the image data 210 as depicting one of a set of predetermined types, classes, or categories of object. For example, to perform semantic segmentation on the image data 210, the image processor 220 classifies and/or categorizes each pixel of the image data 210 as depicting land, sky, water, vehicle (e.g., car), person (e.g., pedestrian), bicycle, plant (e.g., tree), road, structure (e.g., building), pole, sign, animal, other types of objects, or a combination thereof. The segmented image data 225, thus, is divided into segments (e.g., regions, areas) that are labeled, tagged, colored, or shaded differently to reflect different types, classes, or categories of object depicted in the areas of the image data 210 corresponding in location to those segments in the segmented image data 225. In some examples, the image processor 220 generates a confidence value, or a probability value, for its classification of each pixel into one of the predetermined types, classes, or categories of object. Thus, each pixel in the segmented image data 225 can include a corresponding confidence value or probability value with respect to its classification of the pixel into one of the predetermined types, classes, or categories of object.

Within FIG. 2, graphics representing the image processor 220 and the segmented image data 225 both illustrate an example of the segmented image data 225 as generated based on image data 210 as depicted in the graphic representing the image data 210 in FIG. 2. In the graphic for the image processor 220 and the segmented image data 225, different patterns represent different types, classes, or categories of object. For instance, in the graphic for the image processor 220 and the segmented image data 225, land is shown in white, the car is shaded using a cross-hatch pattern, the trees are shaded using a checkerboard pattern, the sky is shaded using a sparsely dotted pattern, and the pedestrian is shaded using a densely dotted pattern.

In some examples, the image processor 220 uses one or more trained machine learning (ML) models 260 to generate the segmented image data 225 based on image data 210. The trained ML model(s) 260 can receive the image data 210 as an input, and can generate the segmented image data 225 or intermediate data that the image processor 220 uses to generate the segmented image data 225, as an output in response. In some examples, the trained ML model(s) 260 are previously trained using training data that includes both image datasets and corresponding pre-segmented image datasets. Training the trained ML model(s) 260 using this dataset can train the trained ML model(s) 260 to generate segmented image data based on image data.

The environment mapping system 200 includes a fusion processor 230 that combines, or fuses, the depth data 215 and the segmented image data 225 to generate a voxel-based map 235 of the environment. In some examples, the fusion processor 230 combines, or fuses, the depth data 215, the segmented image data 225, and the image data 210 to generate the voxel-based map 235 of the environment. To combine the depth data 215, the segmented image data 225, and/or the image data 210, the fusion processor 230 determines the depth of an object in the environment based on portions of the depth data 215 representing the object, and determines the shape and outline and color of the object based on the representation(s) of the object in the segmented image data 225 and/or the image data 210.

In some examples, the fusion processor 230 generates the voxel-based map 235 of the environment so that voxels that represent objects in the environment are labeled or tagged (e.g., as one of the predetermined types, classes, or categories of object) according to the corresponding semantic segments in the segmented image data 225.

In some examples, the fusion processor 230 initiates generation of the voxel-based map 235 of the environment by initiating a voxel grid, with each voxel in the grid being empty or assigned to a “free” or “unassigned” class. The fusion processor 230 assigns probabilities to volumes of voxels in the voxel grid based on the confidence values or probability values of the segmented image data 225. The fusion processor 230 determines the depths for each of those objects based on portions of the depth data 215 representing any portions of those objects, and adjusts the probabilities for the other voxels based on the depth data 215. In some examples, the fusion processor 230 can process a sparse point cloud or semi-dense point cloud (from the depth data 215) based on the segmented image data 225 to generate a dense point cloud, which may be included in the voxel-based map 235 and/or may be a basis for generating the voxel-based map 235. In some examples, the fusion processor 230 relies on a probability graph model to generate the dense point cloud and/or the voxel-based map 235 based on the depth data 215 and the segmented image data 225. In the probability graph model and the voxel-based map 235, each portion of the mapped volume corresponds to at least one voxel, even including portions of the sky. Different voxels can be indicated to have different types, for instance land, sky, vehicle, person, and the like. Voxels can initially have a preliminary voxel type that is unassigned, and the fusion processor 230 can gradually assign more of the voxels to specific voxel types based on the depth data 215 and the segmented image data 225 (and in some cases the image data 210).

Described quantitatively, the probability graph model used by the fusion processor 230 can be described by a function having a number of variables equivalent to the number of voxels in the voxel-based map 235. When a voxel type of a voxel changes, the function value for the corresponding variable changes. To solve the function, the fusion processor 230 performs an inference operation that changes the voxel type(s) of the voxel(s) of the voxel-based map 235 to find an extremum value (e.g., minimum or maximum) of the function for at least a portion of the voxel-based map 235. In some examples, the inference for the extremum value is referred to as a maximum a-posteriori (MAP) estimate.

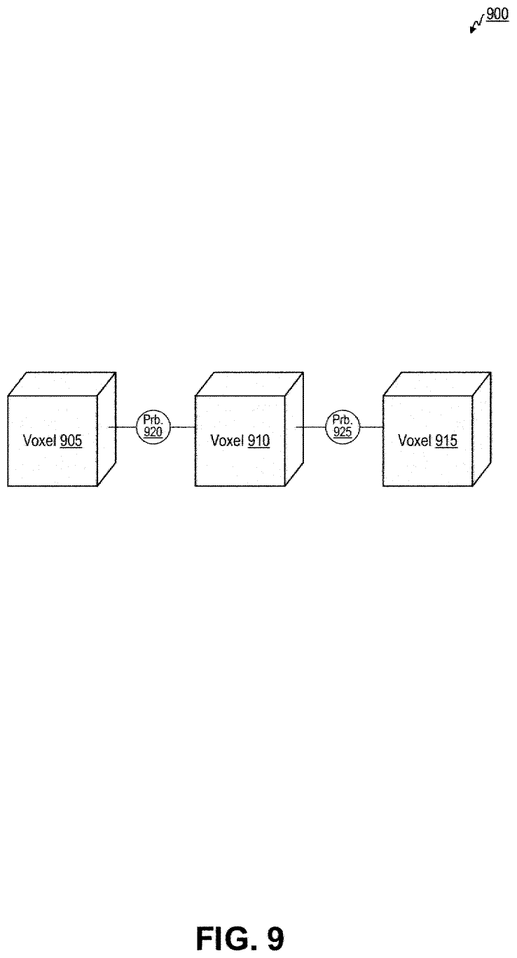

Described qualitatively, each portion of the mapped volume corresponds to at least one voxel that is initially unassigned as described above. Based on the depth data 215 (e.g., the sparse point cloud and/or semi-dense point cloud), the fusion processor 230 updates voxels that correspond to the points in the depth data 215 with voxel types corresponding to the semantic type in the segmented image data 225. Even after this process, certain voxels may be unassigned, for instance those for which there are no points in the depth data 215. In an illustrative example, if a first voxel and a third voxel in a specific row of voxels have a high probability of being of a specific voxel type (e.g., a building), but a second voxel in between the first and third is still unassigned, the inference operation provides a higher probability that the second voxel of the same voxel type as the first and third voxels (e.g., building) than to be free (e.g., sky). This process is further illustrated and discussed with respect to FIG. 9, where, for instance, voxel 905 and voxel 915 can be examples of the first and third voxel, while voxel 910 can be an example of the second voxel.

For instance, based on the segmented image data 225, the fusion processor 230 can determine that a building is located west of the sensor(s) 205. The fusion processor 230 can assign high probabilities of the “building” label or tag to a volume of voxels west of the sensor(s) 205. Based on the depth data 215, the fusion processor 230 can determine that a northern edge of the building and a southern edge of the building are both approximately 8 feet from the sensor(s) 205. The fusion processor 230 can therefore determine that the building is approximately 8 feet west of the sensor(s) 205. Even if the depth data 215 does not include measurements for the entirety of the building, the segmented image data 225 indicates the shape and boundaries of the building to the fusion processor 230, allowing the fusion processor 230 to accurately assign corresponding depths to more of the building than is represented in the depth data 215, for instance by filling in the depth data between the northern edge of the building and the southern edge of the building with a flat or curved surface, depending on the representation(s) of the building in the depth data 215 and/or the image data 210. The in-between voxels can be tagged or labeled as representing the building based on the probability of their representing the building exceeding a threshold, which can be based on the confidence or probability values of the segmented image data 225, and/or based on proximity to other voxels already labeled or tagged as representing the building. For instance, if a first voxel is adjacent to a second voxel that is already labeled or tagged as representing the building, the first voxel is more likely to also be part of the building than to be another class (e.g., ground, tree, etc.). Any voxels between the sensor(s) 205 and the voxels determined to represent the building can then be labeled or tagged as free or unassigned. Any voxels whose probability of representing the building does not exceed the threshold (e.g., falls below the threshold) can also be labeled or tagged as free or unassigned. The fusion processor 230 can continue this process for other objects in the environment, until the entirety of the environment is mapped in the voxel-based map 235 of the environment.

In some examples, the fusion processor 230 removes, or avoids adding, voxels corresponding to dynamic objects (e.g., cars, people, animals, bicycles, or other moving objects) to the voxel-based map 235 of the environment. Put another way, in some examples, the fusion processor 230 only adds voxels corresponding to static objects (e.g., objects that are stationary and/or non-moving) to the voxel-based map 235 of the environment. This can allow the voxel-based map 235 of the environment to be a map of the static portion(s) of the environment.

In some examples, the fusion processor 230 uses the trained ML model(s) 260 to generate the voxel-based map 235 of the environment based on the depth data 215, the segmented image data 225, and/or the image data 210. The trained ML model(s) 260 can receive the depth data 215, the segmented image data 225, and/or the image data 210 as an input, and can generate the voxel-based map 235, or intermediate data that the fusion processor 230 uses to generate the voxel-based map 235, as an output in response. In some examples, the trained ML model(s) 260 are previously trained using training data that includes both input datasets (e.g., with depth data, segmented image data, and/or image data) and corresponding voxel-based maps. Training the trained ML model(s) 260 using this dataset can train the trained ML model(s) 260 to generate voxel-based maps based on depth data, segmented image data, and/or image data.

In some examples, the environment mapping system 200 includes an output processor 240 that generates output data 245 based on the voxel-based map 235 of the environment. In some examples, the output data 245 includes the voxel-based map 235 of the environment. In some examples, the output data 245 includes a route for a vehicle or person to drive or otherwise move through the environment, based on the voxel-based map 235 of the environment. In some examples, the output data 245 includes a command, such as a command to brake, turn left, turn right, accelerate, or maintain speed, to navigate the environment (e.g., to avoid a collision with another object in the environment) based on the voxel-based map 235 of the environment. In some examples, the output data 245 includes two-dimensional representation of the voxel-based map 235 of the environment. In some examples, the output data 245 includes an alert that a certain object is closer than a threshold distance, or is approaching at more than a threshold speed, based on the voxel-based map 235 of the environment. In some examples, the output data 245 includes a change to certain settings or options of a vehicle or other device based on the voxel-based map 235 of the environment. Within FIG. 2, graphics representing the output processor 240 and the output data 245 include a graphic depicting both the graphic representing the voxel-based map 235 of the environment as well as a slider and a gear representing changes to properties or attributes of a vehicle, route, the voxel-based map 235, or any of the other types of output data 245 discussed above.

In some examples, the output processor 240 uses the trained ML model(s) 260 to generate the output data 245 based on the voxel-based map 235 of the environment. The trained ML model(s) 260 can receive the voxel-based map 235 as an input, and can generate the output data 245, or intermediate data that the output processor 240 uses to generate the output data 245, as an output in response. In some examples, the trained ML model(s) 260 are previously trained using training data that includes both voxel-based maps and corresponding pre-generated output data. Training the trained ML model(s) 260 using this dataset can train the trained ML model(s) 260 to generate output data based on voxel-based maps.

The environment mapping system 200 includes one or more output devices 250 configured to output the output data 245 and/or the voxel-based map 235 of the environment. The output device(s) 250 can include one or more visual output devices, such as display(s) or connector(s) therefor. The output device(s) 250 can include one or more audio output devices, such as speaker(s), headphone(s), and/or connector(s) therefor. The output device(s) 250 can include one or more of the output device 1235 and/or of the communication interface 1240 of the computing system 1200. In some examples, the environment mapping system 200 causes the display(s) of the output device(s) 250 to display the output data 245 and/or the voxel-based map 235 of the environment.

In some examples, the output device(s) 250 include one or more transceivers. The transceiver(s) can include wired transmitters, receivers, transceivers, or combinations thereof. The transceiver(s) can include wireless transmitters, receivers, transceivers, or combinations thereof. The transceiver(s) can include one or more of the output device 1235 and/or of the communication interface 1240 of the computing system 1200. In some examples, the environment mapping system 200 causes the transceiver(s) to send, to a recipient device, the output data 245 and/or the voxel-based map 235 of the environment. In some examples, the recipient device can include an HMD 310, a mobile handset 410, a vehicle 510, a vehicle ECU 630, a computing system 1200, or a combination thereof. In some examples, the recipient device can include a display, and the data sent to the recipient device from the transceiver(s) of the output device(s) 250 can cause the display of the recipient device to display the output data 245 and/or the voxel-based map 235 of the environment.

In some examples, the display(s) of the output device(s) 250 of the environment mapping system 200 function as optical “see-through” display(s) that allow light from the real-world environment (scene) around the environment mapping system 200 to traverse (e.g., pass) through the display(s) of the output device(s) 250 to reach one or both eyes of the user. For example, the display(s) of the output device(s) 250 can be at least partially transparent, translucent, light-permissive, light-transmissive, or a combination thereof. In an illustrative example, the display(s) of the output device(s) 250 includes a transparent, translucent, and/or light-transmissive lens and a projector. The display(s) of the output device(s) 250 of can include a projector that projects virtual content (e.g., the output data 245 and/or the voxel-based map 235 of the environment) onto the lens. The lens may be, for example, a lens of a pair of glasses, a lens of a goggle, a contact lens, a lens of a head-mounted display (HMD) device, or a combination thereof. Light from the real-world environment passes through the lens and reaches one or both eyes of the user. The projector can project virtual content (e.g., the output data 245 and/or the voxel-based map 235 of the environment) onto the lens, causing the virtual content to appear to be overlaid over the user's view of the environment from the perspective of one or both of the user's eyes. In some examples, the projector can project the virtual content onto the onto one or both retinas of one or both eyes of the user rather than onto a lens, which may be referred to as a virtual retinal display (VRD), a retinal scan display (RSD), or a retinal projector (RP) display.

In some examples, the display(s) of the output device(s) 250 of the environment mapping system 200 are digital “pass-through” display that allow the user of the environment mapping system 200 and/or a recipient device to see a view of an environment by displaying the view of the environment on the display(s) of the output device(s) 250. The view of the environment that is displayed on the digital pass-through display can be a view of the real-world environment around the environment mapping system 200, for example based on sensor data (e.g., images, videos, depth images, point clouds, other depth data, or combinations thereof) captured by one or more environment-facing sensors of the sensor(s) 205 (e.g., the output data 245 and/or the voxel-based map 235 of the environment). The view of the environment that is displayed on the digital pass-through display can be a virtual environment (e.g., as in VR), which may in some cases include elements that are based on the real-world environment (e.g., boundaries of a room). The view of the environment that is displayed on the digital pass-through display can be an augmented environment (e.g., as in AR) that is based on the real-world environment. The view of the environment that is displayed on the digital pass-through display can be a mixed environment (e.g., as in MR) that is based on the real-world environment. The view of the environment that is displayed on the digital pass-through display can include virtual content (e.g., the output data 245 and/or the voxel-based map 235 of the environment) overlaid over other otherwise incorporated into the view of the environment.

Within FIG. 2, a graphic representing the output device(s) 250 illustrates a display, a speaker, a wireless transceiver, and a vehicle, outputting graphics representing the output data 245 and/or the voxel-based map 235 of the environment using the display, the speaker, the wireless transceiver, and/or a system associated with the vehicle (e.g., controlling computing systems such as an ADAS of the vehicle, IVI systems of the vehicle, autonomous driving systems of the vehicle, semi-autonomous driving systems of the vehicle, or a combination thereof).

The trained ML model(s) 260 can include one or more neural network (NNs) (e.g., neural network 1000), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 2, a graphic representing the trained ML model(s) 260 illustrates a set of circles connected to another. Each of the circles can represent a node (e.g., node 1016), a neuron, a perceptron, a layer, a portion thereof, or a combination thereof. The circles are arranged in columns. The leftmost column of white circles represent an input layer (e.g., input layer 1010). The rightmost column of white circles represent an output layer (e.g., output layer 1014). Two columns of shaded circled between the leftmost column of white circles and the rightmost column of white circles each represent hidden layers (e.g., hidden layers 1012A-1012N).

In some examples, the environment mapping system 200 includes a feedback subsystem 265 of the environment mapping system 200. The feedback subsystem 265 can detect feedback received from a user interface of the environment mapping system 200. The feedback may include feedback on output(s) of the output device(s) 250 (e.g., the output data 245 and/or the voxel-based map 235 of the environment). The feedback subsystem 265 can detect feedback about one subsystem of the environment mapping system 200 received from another subsystem of the environment mapping system 200, for instance whether one subsystem decides to use data from the other subsystem or not. For example, the feedback subsystem 265 can detect whether or not the fusion processor 230 decides to use the segmented image data 225 generated by the image processor 220 based on whether or not the segmented image data 225 works for the needs of the fusion processor 230 for generating the voxel-based map 235 of the environment, and can provide feedback as to the functioning of the trained ML model(s) 260 as used by the image processor 220 to generate the segmented image data 225. Similarly, the feedback subsystem 265 can detect whether or not the output processor 240 decides to use the voxel-based map 235 of the environment generated by the fusion processor 230 based on whether or not the voxel-based map 235 of the environment works for the needs of the output processor 240 for generating the output data 245, and can provide feedback as to the functioning of the trained ML model(s) 260 as used by the fusion processor 230 to generate the voxel-based map 235 of the environment. Similarly, the feedback subsystem 265 can detect whether or not the output device 250 decides to output the output data 245 and/or the voxel-based map 235 of the environment generated by the output processor 240 and/or the fusion processor 230 based on whether or not the output data 245 and/or the voxel-based map 235 works for the needs of the output device 250 for outputting, and can provide feedback as to the functioning of the trained ML model(s) 260 as used by the fusion processor 230 and/or the output processor 240 to generate the voxel-based map 235 and/or the output data 245.

The feedback received by the feedback subsystem 265 can be positive feedback or negative feedback. For instance, if the one subsystem of the environment mapping system 200 uses data from another subsystem of the environment mapping system 200, or if positive feedback from a user is received through a user interface or from one of the subsystems, the feedback subsystem 265 can interpret this as positive feedback. If the one subsystem of the environment mapping system 200 declines to use data from another subsystem of the environment mapping system 200, or if negative feedback from a user is received through a user interface or from one of the subsystems, the feedback subsystem 265 can interpret this as negative feedback. Positive feedback can also be based on attributes of the sensor data from the sensor(s) 205, such as a user smiling, laughing, nodding, saying a positive statement (e.g., “yes,” “confirmed,” “okay,” “next,” “confirmed,” “approved,” “I like this”), or otherwise positively reacting to an output of one of the subsystems described herein, or an indication thereof. Negative feedback can also be based on attributes of the sensor data from the sensor(s) 205, such as the user frowning, crying, shaking their head (e.g., in a “no” motion), saying a negative statement (e.g., “no,” “negative,” “bad,” “not this,” “I hate this,” “this doesn't work,” “this isn't what I wanted”), or otherwise negatively reacting to an output of one of the subsystems described herein, or an indication thereof.

In some examples, the feedback subsystem 265 provides the feedback to one or more ML systems (e.g., the image processor 220, the fusion processor 230, the output processor 240, and/or the trained ML model(s) 260) of the environment mapping system 200 as training data to update the one or more trained ML model(s) 260 of the environment mapping system 200. Positive feedback can be used to strengthen and/or reinforce weights associated with the outputs of the ML system(s) and/or the trained ML model(s) 260, and/or to weaken or remove other weights other than those associated with the outputs of the ML system(s) and/or the trained ML model(s) 260. Negative feedback can be used to weaken and/or remove weights associated with the outputs of the ML system(s) and/or the trained ML model(s) 260, and/or to strengthen and/or reinforce other weights other than those associated with the outputs of the ML system(s) and/or the trained ML model(s) 260.

It should be understood that references herein to the sensor(s) 205, and other sensors described herein, as images sensors should be understood to also include other types of sensors that can produce outputs in image form, such as depth sensors that produce depth maps, depth images, and/or point clouds (e.g., semi-dense point clouds) that can be expressed in image form and/or rendered images of 3D models (e.g., RADAR, LIDAR, SONAR, SODAR, ToF, structured light). It should be understood that references herein to image data, and/or to images, produced by such sensors can include any sensor data that can be output in image form, such as depth maps, depth images, and/or point clouds (e.g., semi-dense point clouds) that can be expressed in image form, and/or rendered images of 3D models.

In some examples, certain elements of the environment mapping system 200 (e.g., the sensor(s) 205, the image processor 220, the fusion processor 230, the output processor 240, the output device(s) 250, the trained ML model(s) 260, the feedback subsystem 265, or a combination thereof) include a software element, such as a set of instructions corresponding to a program (e.g., a hardware driver, a user interface (UI), an application programming interface (API), an operating system (OS), and the like), that is run on a processor such as the processor 1210 of the computing system 1200, the image processor 150, the host processor 152, the ISP 154, a microcontroller, a controller, or a combination thereof. In some examples, one or more of these elements of the environment mapping system 200 can include one or more hardware elements, such as a specialized processor (e.g., the processor 1210 of the computing system 1200, the image processor 150, the host processor 152, the ISP 154, a microcontroller, a controller, or a combination thereof). In some examples, one or more of these elements of the environment mapping system 200 can include a combination of one or more software elements and one or more hardware elements.

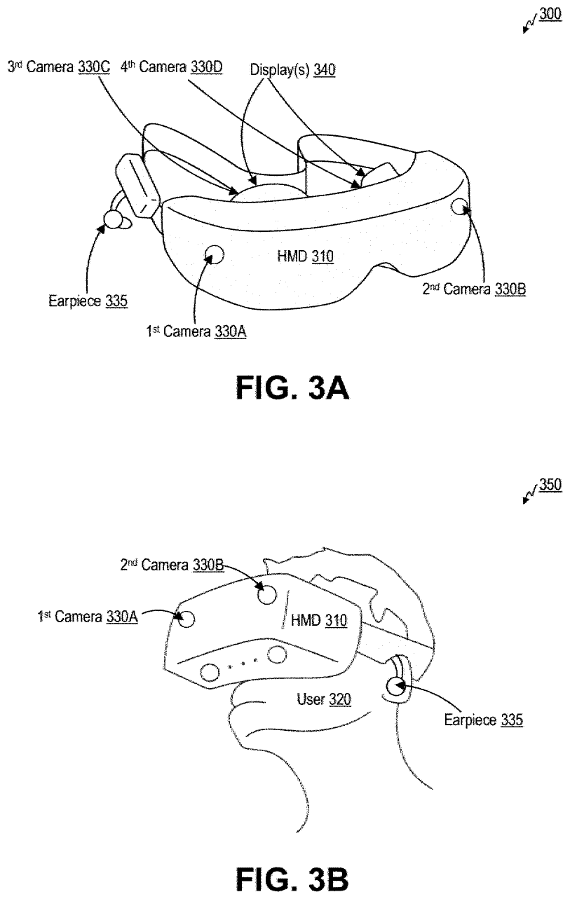

FIG. 3A is a perspective diagram 300 illustrating a head-mounted display (HMD) 310 that is used as part of an environment mapping system 200. The HMD 310 may be, for example, an augmented reality (AR) headset, a virtual reality (VR) headset, a mixed reality (MR) headset, an extended reality (XR) headset, or some combination thereof. The HMD 310 may be an example of an environment mapping system 200. The HMD 310 includes a first camera 330A and a second camera 330B along a front portion of the HMD 310. The first camera 330A and the second camera 330B may be examples of the sensor(s) 205 of the imaging systems 200-200B. The HMD 310 includes a third camera 330C and a fourth camera 330D facing the eye(s) of the user as the eye(s) of the user face the display(s) 340. The third camera 330C and the fourth camera 330D may be examples of the sensor(s) 205 of the imaging systems 200-200B. In some examples, the HMD 310 may only have a single camera with a single image sensor. In some examples, the HMD 310 may include one or more additional cameras in addition to the first camera 330A, the second camera 330B, third camera 330C, and the fourth camera 330D. In some examples, the HMD 310 may include one or more additional sensors in addition to the first camera 330A, the second camera 330B, third camera 330C, and the fourth camera 330D, which may also include other types of sensor(s) 205 of the environment mapping system 200. In some examples, the first camera 330A, the second camera 330B, third camera 330C, and/or the fourth camera 330D may be examples of the image capture and processing system 100, the image capture device 105A, the image processing device 105B, or a combination thereof. In some examples, any of the first camera 330A, the second camera 330B, third camera 330C, and/or the fourth camera 330D can be, or can include, depth sensors.

The HMD 310 may include one or more displays 340 that are visible to a user 320 wearing the HMD 310 on the user 320's head. The one or more displays 340 of the HMD 310 can be examples of the one or more displays of the output device(s) 250 of the imaging systems 200-200B. In some examples, the HMD 310 may include one display 340 and two viewfinders. The two viewfinders can include a left viewfinder for the user 320's left eye and a right viewfinder for the user 320's right eye. The left viewfinder can be oriented so that the left eye of the user 320 sees a left side of the display. The right viewfinder can be oriented so that the right eye of the user 320 sees a right side of the display. In some examples, the HMD 310 may include two displays 340, including a left display that displays content to the user 320's left eye and a right display that displays content to a user 320's right eye. The one or more displays 340 of the HMD 310 can be digital “pass-through” displays or optical “see-through” displays.

The HMD 310 may include one or more earpieces 335, which may function as speakers and/or headphones that output audio to one or more ears of a user of the HMD 310, and may be examples of output device(s) 250. One earpiece 335 is illustrated in FIGS. 3A and 3B, but it should be understood that the HMD 310 can include two earpieces, with one earpiece for each ear (left car and right car) of the user. In some examples, the HMD 310 can also include one or more microphones (not pictured). The one or more microphones can be examples of the sensor(s) 205 of the imaging systems 200-200B. In some examples, the audio output by the HMD 310 to the user through the one or more earpieces 335 may include, or be based on, audio recorded using the one or more microphones.

FIG. 3B is a perspective diagram 350 illustrating the head-mounted display (HMD) of FIG. 3A being worn by a user 320. The user 320 wears the HMD 310 on the user 320's head over the user 320's eyes. The HMD 310 can capture images with the first camera 330A and the second camera 330B. In some examples, the HMD 310 displays one or more output images toward the user 320's eyes using the display(s) 340. In some examples, the output images can include the output data 245 and/or the voxel-based map 235 of the environment. The output images can be based on the images captured by the first camera 330A and the second camera 330B (e.g., the image data 210 and/or depth data 215), for example with the virtual content (e.g., the output data 245 and/or the voxel-based map 235 of the environment) overlaid. The output images may provide a stereoscopic view of the environment, in some cases with the virtual content overlaid and/or with other modifications. For example, the HMD 310 can display a first display image to the user 320's right eye, the first display image based on an image captured by the first camera 330A. The HMD 310 can display a second display image to the user 320's left eye, the second display image based on an image captured by the second camera 330B. For instance, the HMD 310 may provide overlaid virtual content in the display images overlaid over the images captured by the first camera 330A and the second camera 330B. The third camera 330C and the fourth camera 330D can capture images of the eyes of the before, during, and/or after the user views the display images displayed by the display(s) 340. This way, the sensor data from the third camera 330C and/or the fourth camera 330D can capture reactions to the virtual content by the user's eyes (and/or other portions of the user). An earpiece 335 of the HMD 310 is illustrated in an car of the user 320. The HMD 310 may be outputting audio to the user 320 through the earpiece 335 and/or through another earpiece (not pictured) of the HMD 310 that is in the other ear (not pictured) of the user 320.

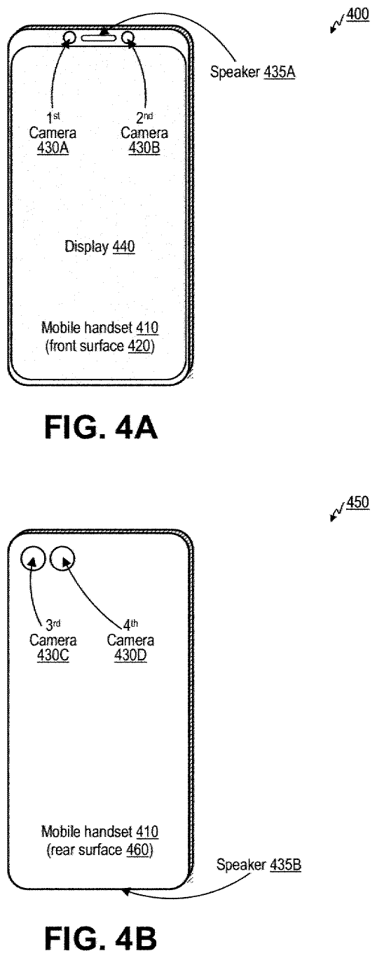

FIG. 4A is a perspective diagram 400 illustrating a front surface of a mobile handset 410 that includes front-facing cameras and can be used as part of an environment mapping system 200.

The mobile handset 410 may be an example of an environment mapping system 200. The mobile handset 410 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 420 of the mobile handset 410 includes a display 440. The front surface 420 of the mobile handset 410 includes a first camera 430A and a second camera 430B. The first camera 430A and the second camera 430B may be examples of the sensor(s) 205 of the imaging systems 200-200B. The first camera 430A and the second camera 430B can face the user, including the eye(s) of the user, while content (e.g., the output data 245 and/or the voxel-based map 235 of the environment) is displayed on the display 440. The display 440 may be an example of the display(s) of the output device(s) 250 of the imaging systems 200-200B.

The first camera 430A and the second camera 430B are illustrated in a bezel around the display 440 on the front surface 420 of the mobile handset 410. In some examples, the first camera 430A and the second camera 430B can be positioned in a notch or cutout that is cut out from the display 440 on the front surface 420 of the mobile handset 410. In some examples, the first camera 430A and the second camera 430B can be under-display cameras that are positioned between the display 440 and the rest of the mobile handset 410, so that light passes through a portion of the display 440 before reaching the first camera 430A and the second camera 430B. The first camera 430A and the second camera 430B of the perspective diagram 400 are front-facing cameras. The first camera 430A and the second camera 430B face a direction perpendicular to a planar surface of the front surface 420 of the mobile handset 410. The first camera 430A and the second camera 430B may be two of the one or more cameras of the mobile handset 410. In some examples, the front surface 420 of the mobile handset 410 may only have a single camera.

In some examples, the display 440 of the mobile handset 410 displays one or more output images toward the user using the mobile handset 410. In some examples, the output images can include the output data 245 and/or the voxel-based map 235 of the environment. The output images can be based on the images (e.g., the image data 210 and/or the depth data 215) captured by the first camera 430A, the second camera 430B, the third camera 430C, and/or the fourth camera 430D, for example with the virtual content (e.g., the output data 245 and/or the voxel-based map 235 of the environment) overlaid.

In some examples, the front surface 420 of the mobile handset 410 may include one or more additional cameras in addition to the first camera 430A and the second camera 430B. The one or more additional cameras may also be examples of the sensor(s) 205 of the imaging systems 200-200B. In some examples, the front surface 420 of the mobile handset 410 may include one or more additional sensors in addition to the first camera 430A and the second camera 430B. The one or more additional sensors may also be examples of the sensor(s) 205 of the imaging systems 200-200B. In some cases, the front surface 420 of the mobile handset 410 includes more than one display 440. The one or more displays 440 of the front surface 420 of the mobile handset 410 can be examples of the display(s) of the output device(s) 250 of the imaging systems 200-200B. For example, the one or more displays 440 can include one or more touchscreen displays.

The mobile handset 410 may include one or more speakers 435A and/or other audio output devices (e.g., earphones or headphones or connectors thereto), which can output audio to one or more ears of a user of the mobile handset 410. One speaker 435A is illustrated in FIG. 4A, but it should be understood that the mobile handset 410 can include more than one speaker and/or other audio device. In some examples, the mobile handset 410 can also include one or more microphones (not pictured). The one or more microphones can be examples of the sensor(s) 205 of the imaging systems 200-200B. In some examples, the mobile handset 410 can include one or more microphones along and/or adjacent to the front surface 420 of the mobile handset 410, with these microphones being examples of the sensor(s) 205 of the imaging systems 200-200B. In some examples, the audio output by the mobile handset 410 to the user through the one or more speakers 435A and/or other audio output devices may include, or be based on, audio recorded using the one or more microphones.

FIG. 4B is a perspective diagram 450 illustrating a rear surface 460 of a mobile handset that includes rear-facing cameras and that can be used as part of an environment mapping system 200. The mobile handset 410 includes a third camera 430C and a fourth camera 430D on the rear surface 460 of the mobile handset 410. The third camera 430C and the fourth camera 430D of the perspective diagram 450 are rear-facing. The third camera 430C and the fourth camera 430D may be examples of the sensor(s) 205 of the imaging systems 200-200B of FIG. 2. The third camera 430C and the fourth camera 430D face a direction perpendicular to a planar surface of the rear surface 460 of the mobile handset 410.

The third camera 430C and the fourth camera 430D may be two of the one or more cameras of the mobile handset 410. In some examples, the rear surface 460 of the mobile handset 410 may only have a single camera. In some examples, the rear surface 460 of the mobile handset 410 may include one or more additional cameras in addition to the third camera 430C and the fourth camera 430D. The one or more additional cameras may also be examples of the sensor(s) 205 of the imaging systems 200-200B. In some examples, the rear surface 460 of the mobile handset 410 may include one or more additional sensors in addition to the third camera 430C and the fourth camera 430D. The one or more additional sensors may also be examples of the sensor(s) 205 of the imaging systems 200-200B. In some examples, the first camera 430A, the second camera 430B, third camera 430C, and/or the fourth camera 430D may be examples of the image capture and processing system 100, the image capture device 105A, the image processing device 105B, or a combination thereof. In some examples, any of the first camera 430A, the second camera 430B, third camera 430C, and/or the fourth camera 430D can be, or can include, depth sensors.

The mobile handset 410 may include one or more speakers 435B and/or other audio output devices (e.g., earphones or headphones or connectors thereto), which can output audio to one or more ears of a user of the mobile handset 410. One speaker 435B is illustrated in FIG. 4B, but it should be understood that the mobile handset 410 can include more than one speaker and/or other audio device. In some examples, the mobile handset 410 can also include one or more microphones (not pictured). The one or more microphones can be examples of the sensor(s) 205 of the imaging systems 200-200B. In some examples, the mobile handset 410 can include one or more microphones along and/or adjacent to the rear surface 460 of the mobile handset 410, with these microphones being examples of the sensor(s) 205 of the imaging systems 200-200B. In some examples, the audio output by the mobile handset 410 to the user through the one or more speakers 435B and/or other audio output devices may include, or be based on, audio recorded using the one or more microphones.

The mobile handset 410 may use the display 440 on the front surface 420 as a pass-through display. For instance, the display 440 may display output images, such as the output data 245 and/or the voxel-based map 235 of the environment. The output images can be based on the images (e.g. the image data 210 and/or the depth data 215) captured by the third camera 430C and/or the fourth camera 430D, for example with the virtual content (e.g., the output data 245 and/or the voxel-based map 235 of the environment) overlaid. The first camera 430A and/or the second camera 430B can capture images of the user's eyes (and/or other portions of the user) before, during, and/or after the display of the output images with the virtual content on the display 440. This way, the sensor data from the first camera 430A and/or the second camera 430B can capture reactions to the virtual content by the user's eyes (and/or other portions of the user).

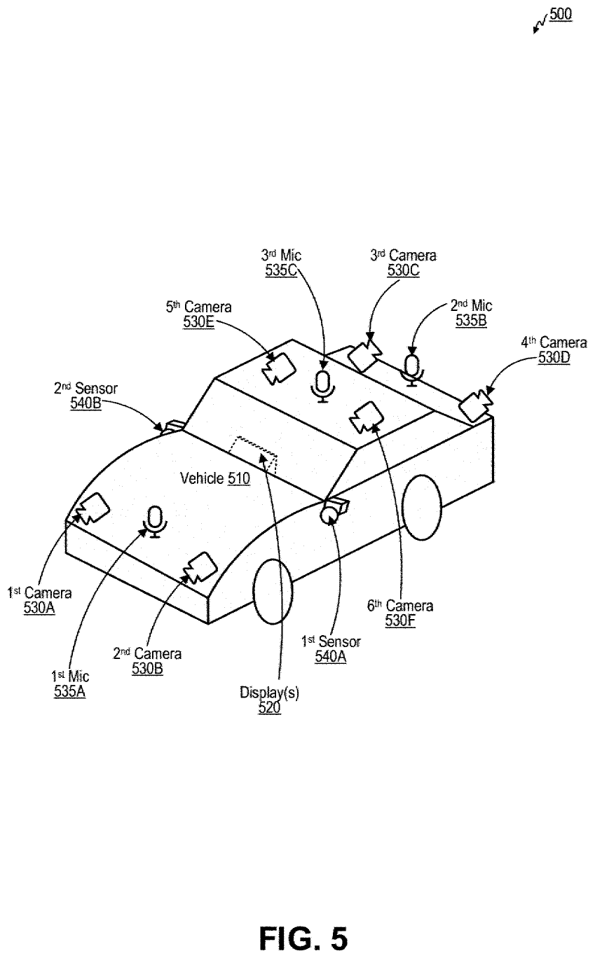

FIG. 5 is a perspective diagram 500 illustrating a vehicle 510 that includes various sensors. The vehicle 510 may be an example of an environment mapping system 200. The vehicle 510 is illustrated as an automobile, but may be, for example, an automobile, a truck, a bus, a train, a ground-based vehicle, an airplane, a helicopter, an aircraft, an aerial vehicle, a boat, a submarine, a watercraft, an underwater vehicle, a hovercraft, another type of vehicle discussed herein, or a combination thereof. In some examples, the vehicle 510 may be manned, unmanned, autonomous, semi-autonomous, remote-controlled, or a combination thereof. In some examples, the vehicle may be at least partially controlled and/or used with sub-systems of the vehicle 510, such as ADAS of the vehicle 510, IVI systems of the vehicle 510, autonomous driving systems of the vehicle 510, semi-autonomous driving systems of the vehicle 510, a vehicle electronic control unit (ECU) 630 of the vehicle 510, or a combination thereof.

The vehicle 510 includes a display 520. The vehicle 510 includes various sensors, all of which can be examples of the sensor(s) 205. The vehicle 510 includes a first camera 530A and a second camera 530B at the front, a third camera 530C and a fourth camera 530D at the rear, and a fifth camera 530E and a sixth camera 530F on the top. The vehicle 510 includes a first microphone 535A at the front, a second microphone 535B at the rear, and a third microphone 535C at the top. The vehicle 510 includes a first sensor 540A on one side (e.g., adjacent to one rear-view mirror) and a second sensor 540B on another side (e.g., adjacent to another rear-view mirror). The first sensor 540A and the second sensor 540B may include cameras, microphones, depth sensors (e.g., RADAR sensors, LIDAR sensors), or any other types of sensors(s) 205 described herein. In some examples, the vehicle 510 may include additional sensor(s) 205 in addition to the sensors illustrated in FIG. 5. In some examples, the vehicle 510 may be missing some of the sensors that are illustrated in FIG. 5.

In some examples, the display 520 of the vehicle 510 displays one or more output images toward a user of the vehicle 510 (e.g., a driver and/or one or more passengers of the vehicle 510). In some examples, the output images can include the output data 245 and/or the voxel-based map 235 of the environment. The output images can be based on the images (e.g., the image data 210 and/or the depth data 215) captured by the first camera 530A, the second camera 530B, the third camera 530C, the fourth camera 530D, the fifth camera 530E, the sixth camera 530F, the first sensor 540A, and/or the second sensor 540B, for example with the virtual content (e.g., the output data 245 and/or the voxel-based map 235 of the environment) overlaid. In some examples, any of the first camera 530A, the second camera 530B, the third camera 530C, the fourth camera 530D, the fifth camera 530E, the sixth camera 530F, the first sensor 540A, and/or the second sensor 540B can be, or can include, depth sensors.

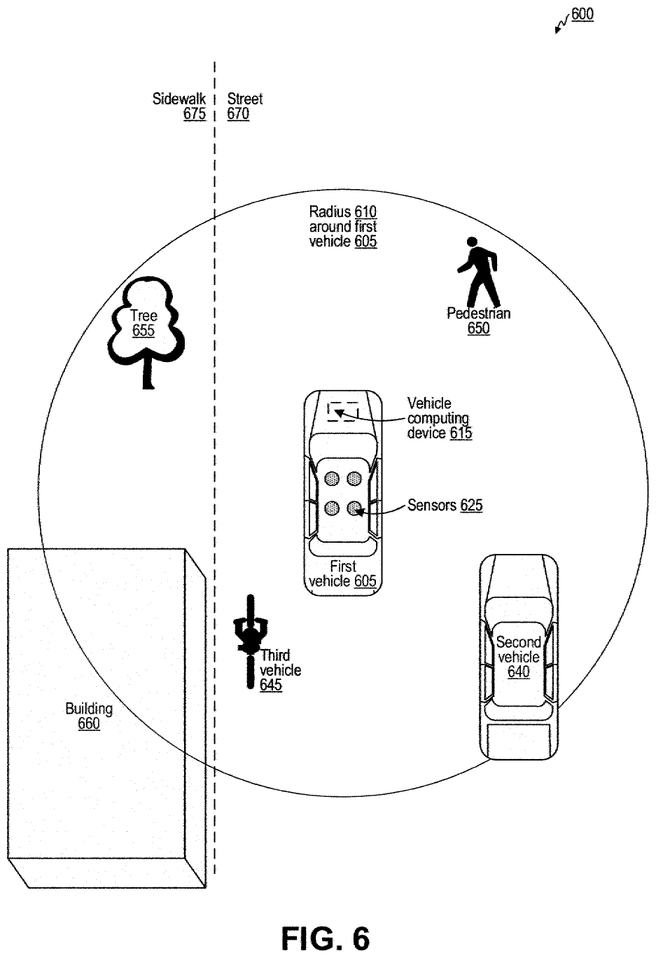

FIG. 6 is a perspective diagram 600 illustrating a first vehicle 605 located in an environment. The first vehicle 605 includes one or more sensor(s). In particular, FIG. 6 illustrates a first vehicle 605 with an vehicle computing device 615 (illustrated as a box with a dashed outline) and four sensors 625 (illustrated as shaded circles). The first vehicle 605 may be a vehicle (e.g., vehicle 190, vehicle 510) with an environment mapping system 200. The sensors 625 may be examples of the image capture and processing system 100, the image capture device 105A, the image processing device 105B, the sensor(s) 205, the cameras 330A-330D, the cameras 430A-430D, the cameras 530A-530F, the microphones 535A-535C, the sensors 540A-540B, or a combination thereof. In some examples, the sensors 625 may include image sensor(s) and/or depth sensor(s). The vehicle computing device 615 may be examples of the image capture and processing system 100, the image processing device 105B, the environment mapping system 200, the computing system 1200, or a combination thereof. The sensors 625 may be at least a subset of the sensors 180 of the vehicle 605.

A radius 610 is illustrated in the environment around the first vehicle 605, representing a range associated with the sensors 625. A dashed line runs through the radius 610, with street 670 on the right of the dashed line and sidewalk 675 on the left of the dashed line. On the street 670, a second vehicle 640 (a car), a third vehicle 645 (a bicycle and bicyclist), and a pedestrian 650 are within the radius 610. On the sidewalk 675, a tree 655 and a building 660 are within the radius 610.

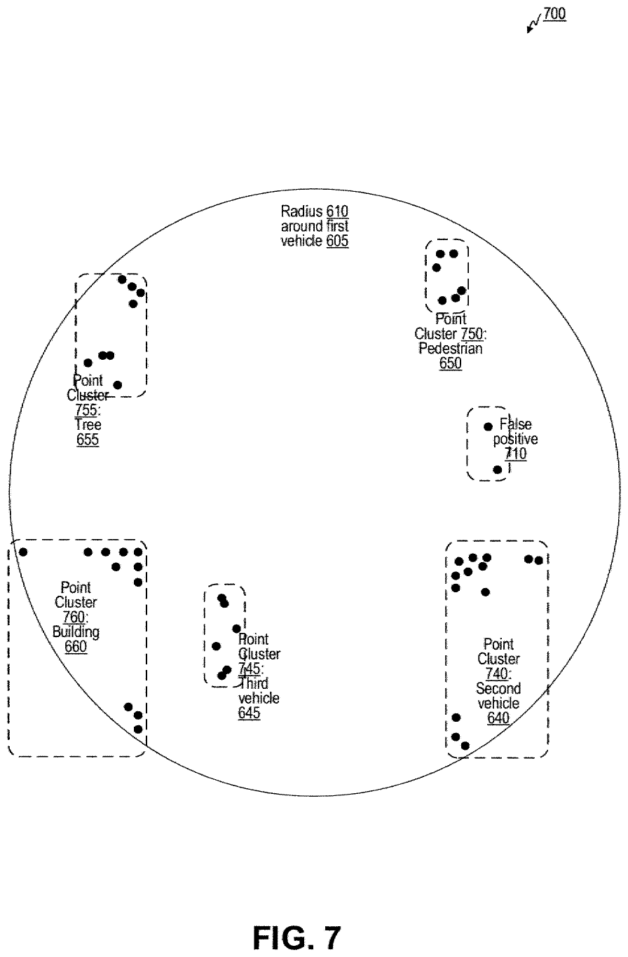

FIG. 7 is a perspective diagram 700 illustrating a depth data 215 representing the environment of FIG. 6 as captured using a depth sensor of the first vehicle 605. The radius 610 is still shown in FIG. 7. A cluster of points 750 is located in the same general area as the edge(s) of the pedestrian 650 in FIG. 6. Thus, the cluster of points 750 represents the pedestrian 650. A cluster of points 740 is located in the same general area as the edge(s) of the second vehicle (car) 640 in FIG. 6. Thus, the cluster of points 740 represents the second vehicle (car) 640. A cluster of points 745 is located in the same general area as the edge(s) of the third vehicle (bicycle and bicyclist) 645 in FIG. 6. Thus, the cluster of points 745 represents the third vehicle (bicycle and bicyclist) 645. A cluster of points 755 is located in the same general area as the edge(s) of the tree 655 in FIG. 6. Thus, the cluster of points 755 represents the tree 655. A cluster of points 760 is located in the same general area as the building 660 in FIG. 6. Thus, the cluster of points 760 represents the building 660.

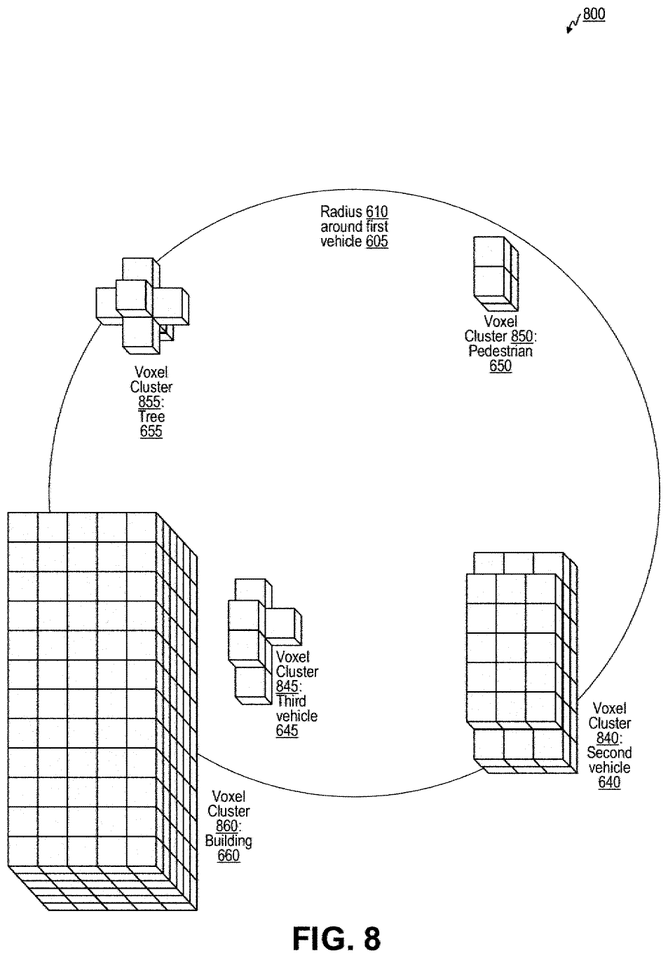

In some cases, depth sensors of the sensors 625 may only be able to detect portions of an object that are closest to the sensors 625. Those portions may then occlude portions of the object that are farthest from the sensors 625, since the closer portions of the object already reflected the signals from the distance measurement sensors back to the distance measurement sensors. Similarly, in some cases, depth sensors of the sensors 625 may only be able to detect edges of an object, without detecting surfaces in between those edges. Thus, the cluster of points 740 representing the second vehicle (car) 640 has several points along the top-left edge, bottom-left edge, top side (near these edges), and left side (near these edges) of the second vehicle (car) 640, but lacks points away from edges, and lacks points along the bottom and right sides of the second vehicle (car) 640, since signals from the distance measurement sensors 625 of the first vehicle 605 generally reflect off of the top and left sides of the second vehicle (car) 640 and do not reach the bottom and right sides of the second vehicle (car) 640. Based on segmented image data 225, the vehicle computing device 615 of the vehicle 605 can determine that the cluster of points 740 representing the second vehicle (car) 640 is co-located with a segment representing the second vehicle (car) 640, and can thus determine that the cluster of points 740 represents a car (i.e., the second vehicle (car) 640). The vehicle computing device 615 of the vehicle 605 can “fill in” voxels (e.g., tag or label as corresponding to the second vehicle (car) 640) for the portions without points in the depth data (e.g., the surfaces between the edges and the occluded areas) based on this classification, based on the shape of the second vehicle (car) 640 in the segmented image data 225 and/or in the image data 210 itself, and/or based on reference data indicating one or more common car shapes. Likewise, the cluster of points 760 representing the building 660 has points along the top-right edge, the top side (near the edge), and right side (near the edge) of the building 660, but lacks points away from edges, and lacks points along the bottom and left sides of the building 660, since signals from the distance measurement sensors 625 of the first vehicle 605 generally reflect off of the top and right sides of the building 660 and do not reach the bottom and left sides of the building 660, and since the building 660 extends out of the radius 610. In converting the point cloud of FIG. 7 to the voxel-based map of FIG. 8, the vehicle computing device 615 of the vehicle 605 may use the segmented image data 225 to determine that the cluster of points 760 is part of a building (i.e., the building 660). The vehicle computing device 615 of the vehicle 605 can “fill in” voxels (e.g., tag or label as corresponding to the building 660) for the portions without points in the depth data (e.g., the surfaces between the edges and the occluded areas) based on this classification, based on the shape of the building 660 in the segmented image data 225 and/or in the image data 210 itself, and/or based on reference data indicating one or more common building shapes.

The point cloud of FIG. 7 also includes two points were nothing exists. These points represent a false positive 710, and should therefore be filtered out and not be converted into a voxel in the voxel-based map of FIG. 6 or FIG. 8. In some examples, points representing portion(s) of the vehicle 605, the sky, the street 670, and/or the sidewalk 675 may also be filtered out of the depth data 215.

FIG. 8 is a perspective diagram 800 illustrating a voxel-based three-dimensional map representing the environment of FIG. 6 generated using the depth data of FIG. 7 and image data of the environment captured using an image sensor of the first vehicle 605. The voxels of the voxel-based map of FIG. 8 are illustrated as white cubes with black outlines. In other voxel-based maps, the voxels can be oblong (non-cubic) rectangular prisms or other polyhedrons.

The radius 610 is still shown in FIG. 8. Voxels that are labeled as free or unassigned are not illustrated in the voxel-based map of FIG. 8. Voxels that are labeled as part of a particular object are illustrated as solid white cubes with black outlines in the voxel-based map of FIG. 8. The first vehicle 605, the sky, and the ground (e.g., the street 670 and/or the sidewalk 675) are not illustrated in the voxel-based map of FIG. 8, as any points corresponding to any of these objects in the depth data 215 may be filtered out and/or left unused in the voxel-based map of FIG. 8 based on classification of these objects in the segmented image data 225. Similarly, the points representing the false positive 710 in FIG. 7 have no analogous voxels in the voxel-based map of FIG. 8, since these do not correspond to an object in the segmented image data 225, or correspond to an object (such as the sky) that is configured to be set as free or unassigned in the voxel-based map of FIG. 8.

A cluster of voxels 850 is located in the same general area as the pedestrian 650 is in FIG. 6, and as the corresponding cluster of points 750 of points is in FIG. 7. Thus, the cluster of voxels 850 represents the pedestrian 650. A cluster of voxels 840 is located in the same general area as the second vehicle (car) 640 is in FIG. 6, and as the corresponding cluster of points 740 of points is in FIG. 7. Thus, the cluster of voxels 840 represents the second vehicle (car) 640. A cluster of voxels 845 is located in the same general area as the third vehicle (bicycle and bicyclist) 645 is in FIG. 6, and as the corresponding cluster of points 745 of points is in FIG. 7. Thus, the cluster of voxels 845 represents the third vehicle (bicycle and bicyclist) 645. A cluster of voxels 855 is located in the same general area as the tree 655 is in FIG. 6, and as the corresponding cluster of points 755 of points is in FIG. 7. Thus, the cluster of voxels 855 represents the tree 655. A cluster of voxels 860 is located in the same general area as the building 660 is in FIG. 6, and as the corresponding cluster of points 760 of points is in FIG. 7. Thus, the cluster of voxels 860 represents the building 660. As discussed above with respect to FIG. 7, in the voxel-based map of FIG. 8, voxels are included even for areas of the objects that are not represented in the depth data 215 (e.g., the various clusters of points illustrated in FIG. 7) based on the vehicle computing device 615 of the vehicle 605 “filling in” voxels (e.g., tagging or labelling the voxels as corresponding to a particular object) for the portions without points in the depth data (e.g., the surfaces between the edges and the occluded areas) based on this classification, based on the shape of the object in the segmented image data 225 and/or in the image data 210 itself, and/or based on reference data indicating one or more common shapes for the object.

FIG. 9 is a conceptual diagram 900 illustrating probabilities for classification of adjacent voxels. Three adjacent voxels are illustrated in FIG. 9, including a voxel 905, a voxel 910, and a voxel 915. The voxel 910 is in between the voxel 905 and the voxel 915. An environment mapping system (e.g., environment mapping system 200) can build a probabilistic graph model for classification of the voxels, inferenced using maximum a posteriori (MAP) estimation. According to some examples, a voxel's classification may be selected according to Equation 1 below:

$$F ( voxel 905 , voxel 910 , voxel 915 ) = Max ( P ( voxel 905 , voxel 910 , voxel 915 ) ) \qquad Equation 1$$

In an illustrative example, an environment mapping system (e.g., environment mapping system 200) can determine probabilities that an individual voxel is classified as a particular type of object based on a corresponding location in segmented image data 225 being classified as that particular type of object. Based on this type of probability assessment, in an illustrative example, an environment mapping system may determine the probabilities for the voxels of FIG. 9 according to Equations 2 through 10 below:

$$P ( voxel 905 == tree ) = 0.1 \qquad Equation 2$$

$$P ( voxel 905 == building ) = 0.8 \qquad Equation 3$$

$$P ( voxel 905 == free ) = 0.1 \qquad Equation 4$$

$$P ( voxel 910 == tree ) = 0.1 \qquad Equation 5$$

$$P ( voxel 910 == building ) = 0.1 \qquad Equation 6$$

$$P ( voxel 910 == free ) = 0.8 \qquad Equation 7$$

$$P ( voxel 915 == tree ) = 0.1 \qquad Equation 8$$

$$P ( voxel 915 == building ) = 0.7 \qquad Equation 9$$

$$P ( voxel 915 == free ) = 0.2 \qquad Equation 10$$

The probability 920 and the probability 925 may be pairwise probability functions that increase the probability (relative to the individual probabilities for individual voxels) that neighboring voxels are categorized as the same type of object and decrease the probability (relative to the individual probabilities for individual voxels) that neighboring voxels are categorized as the same type of object. For instance, the probability 920 may be a probability of voxel 905 being a certain type of object and of voxel 910 being a certain type of object, while probability 925 may be a probability of voxel 910 being a certain type of object and of voxel 915 being a certain type of object. Based on this type of probability assessment, in an illustrative example, an environment mapping system may determine the pairwise probabilities (e.g., probability 920 and the probability 925) for the voxels of FIG. 9 according to Equations 11 through 14 below:

$$P ( tree , tree ) = 0.5 \qquad Equation 11$$

$$P ( building , building ) = 0.6 \qquad Equation 12$$

$$P ( free , free ) = 0.5 \qquad Equation 13$$

$$P ( building , tree ) = 0.1 \qquad Equation 14$$

For instance, in Equations 11 through 13, the pairwise probabilities are high, because neighboring voxels are encouraged to be categorized as the same type of object. On the other hand, in Equation 14, the pairwise probability is low, because neighboring voxels are discouraged to be categorized as the different types of objects.

To factor in multiple neighboring voxels, environment mapping system (e.g., environment mapping system 200) can factor in multiple individual probabilities (e.g., as in Equations 2 through 10) as well as pairwise probabilities (e.g., as in probability 920, probability 925, and/or Equations 11 through 14), for instance according to Equation 15 below:

$$Max ( P ( voxel 905 , voxel 910 , voxel 915 ) ) = P ( voxel 905 ) * P ( voxel 910 ) * P ( voxel 915 ) * ( Probability 920 ) * ( Probability 925 ) \qquad Equation 15$$

In this way, the classification for voxel 910, for instance, can be based on individual probabilities for voxels 905-915, pairwise probability 920, and/or pairwise probability 925.

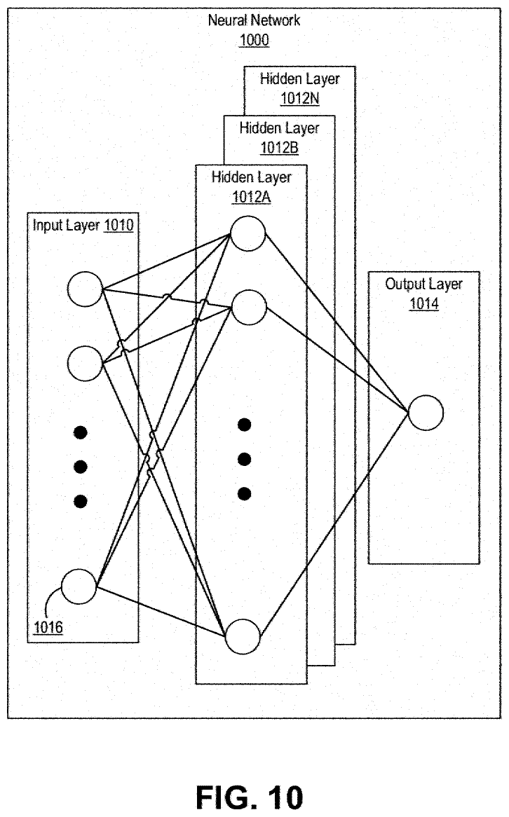

FIG. 10 is a block diagram illustrating an example of a neural network (NN) 1000 that can be used for media processing operations. The neural network 1000 can include any type of deep network, such as a convolutional neural network (CNN), an autoencoder, a deep belief net (DBN), a Recurrent Neural Network (RNN), a Generative Adversarial Networks (GAN), and/or other type of neural network. The neural network 1000 may be an example of one of the trained ML model(s) 260. The neural network 1000 may used by the image processor 220 (e.g., for semantic segmentation), the fusion processor 230 (e.g., for voxel mapping), the output processor 240 (e.g., for generating the output data 245), or a combination thereof.

An input layer 1010 of the neural network 1000 includes input data. The input data of the input layer 1010 can include data representing the pixels of one or more input image frames. In some examples, the input data of the input layer 1010 includes data representing the pixels of image data and/or depth data (e.g., an image captured by the image capture and processing system 100, the image data 210, the depth data 215, other sensor data captured by the sensor(s) 205, an image captured by one of the cameras 330A-330D, an image captured by one of the cameras 430A-430D, an image captured by one of the cameras 530A-530F, an image captured by one of the sensors 625, the raw image data and/or depth data of operation 1005, or a combination thereof. In some examples, the input data of the input layer 1010 includes processed data that is to be processed further, such as the segmented image data 225 and/or the voxel-based map 235.

The images can include image data from an image sensor including raw pixel data (including a single color per pixel based, for example, on a Bayer filter) or processed pixel values (e.g., RGB pixels of an RGB image). The neural network 1000 includes multiple hidden layers 1012, 1012B, through 1012N. The hidden layers 1012, 1012B, through 1012N include “N” number of hidden layers, where “N” is an integer greater than or equal to one. The number of hidden layers can be made to include as many layers as needed for the given application. The neural network 1000 further includes an output layer 1014 that provides an output resulting from the processing performed by the hidden layers 1012, 1012B, through 1012N.

In some examples, the output layer 1014 can provide output data, such as the segmented image data 225, the voxel-based map 235, the output data 245, or intermediate data used (e.g., by the image processor 220, the fusion processor 230, and/or the output processor 240) for generating any of these.

The neural network 1000 is a multi-layer neural network of interconnected filters. Each filter can be trained to learn a feature representative of the input data. Information associated with the filters is shared among the different layers and each layer retains information as information is processed. In some cases, the neural network 1000 can include a feed-forward network, in which case there are no feedback connections where outputs of the network are fed back into itself. In some cases, the network 1000 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 1010 can activate a set of nodes in the first hidden layer 1012A. For example, as shown, each of the input nodes of the input layer 1010 can be connected to each of the nodes of the first hidden layer 1012A. The nodes of a hidden layer can transform the information of each input node by applying activation functions (e.g., filters) to this information. The information derived from the transformation can then be passed to and can activate the nodes of the next hidden layer 1012B, which can perform their own designated functions. Example functions include convolutional functions, downscaling, upscaling, data transformation, and/or any other suitable functions. The output of the hidden layer 1012B can then activate nodes of the next hidden layer, and so on. The output of the last hidden layer 1012N can activate one or more nodes of the output layer 1014, which provides a processed output image. In some cases, while nodes (e.g., node 1016) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1010 using the different hidden layers 1012, 1012B, through 1012N in order to provide the output through the output layer 1014.

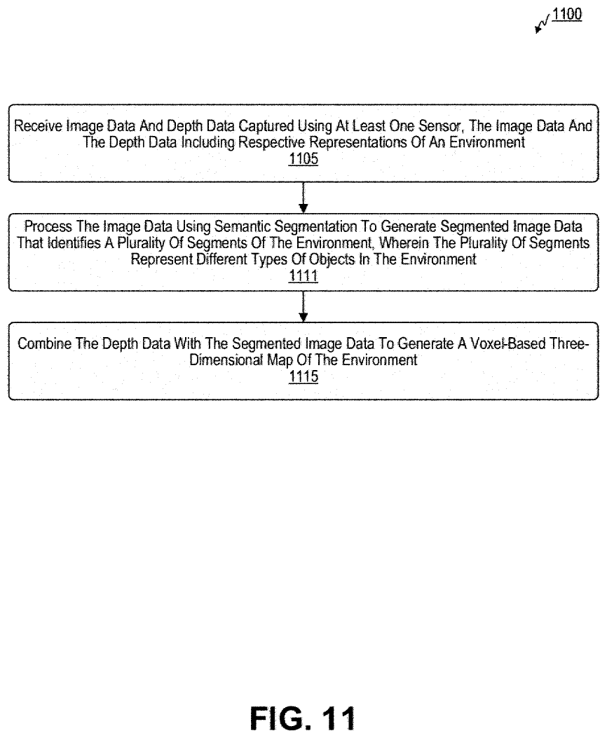

FIG. 11 is a flow diagram illustrating a process 1100 for imaging. The process 1100 for imaging may be performed by an environment mapping system (e.g., a chipset, a processor or multiple processors such as an ISP, HP, or other processor, or other component). In some examples, the environment mapping system can include, for example, the image capture and processing system 100, the image capture device 105A, the image processing device 105B, the image processor 150, the ISP 154, the host processor 152, the vehicle 190, the environment mapping system 200, the sensor(s) 205, the image processor 220, the fusion processor 230, the output processor 240, the output device(s) 250, the trained ML model(s) 260, the feedback subsystem 265, the HMD 310, the mobile handset 410, the vehicle 510, the first vehicle 605, the vehicle computing device 615, the sensors 625, the neural network 1000, the computing system 1200, the processor 1210, or a combination thereof. In some examples, the imaging system includes a display. In some examples, the imaging system includes a transceiver.

At operation 1105, the environment mapping system (or component thereof) is configured to, and can, receive image data (e.g., image data 210) and depth data (e.g., depth data 215) captured using at least one sensor (e.g., sensor(s) 205). The image data and the depth data include respective representations of an environment.

In some aspects, the at least one sensor includes an image sensor, and the image sensor is configured to capture at least the image data. In some aspects, the depth data is based on the image data from the image sensor (e.g., as time of flight (ToF) data, structured light data, and/or stereoscopic camera based depth detection). In some aspects, the at least one sensor includes a depth sensor (e.g., RADAR, LIDAR, SONAR, SODAR, ToF sensor, structured light sensor, and/or stereoscopic camera), and the depth sensor is configured to capture at least the depth data.

Illustrative examples of the image sensor includes the image sensor 130, the sensor(s) 205, the first camera 330A, the second camera 330B, the third camera 330C, the fourth camera 330D, the first camera 430A, the second camera 430B, the third camera 430C, the fourth camera 430D, the first camera 530A, the second camera 530B, the third camera 530C, the fourth camera 530D, the fifth camera 530E, the sixth camera 530F, the first sensor 540A, the second sensor 540B, the sensors 625, an image sensor used to capture an image used as input data for the input layer 1010 of the NN 1000, the input device 1245, another image sensor described herein, another sensor described herein, or a combination thereof. Examples of the depth sensor includes the sensor(s) 205, the first sensor 540A, the second sensor 540B, the sensors 625, a depth sensor used to capture depth data used as input data for the input layer 1010 of the NN 1000, the input device 1245, another depth sensor described herein, another sensor described herein, or a combination thereof. Examples of the image data include the image data 210 and/or image data captured by any of the previously-listed image sensors. Examples of the depth data include the depth data 215, the depth data illustrated in FIG. 7, and/or depth data captured by any of the previously-listed image sensors.

At operation 1110, the environment mapping system (or component thereof) is configured to, and can, process the image data using semantic segmentation (e.g., via image processor 220) to generate (e.g., using the image processor 220) segmented image data that identifies a plurality of segments of the environment. The plurality of segments represent different types of objects in the environment. An example of the segmented image data includes the segmented image data 225.

At operation 1115, the environment mapping system (or component thereof) is configured to, and can, combine the depth data with the segmented image data (e.g., using the fusion processor 230 and/or the output processor 240) to generate a voxel-based three-dimensional map of the environment. Examples of the voxel-based three-dimensional map of the environment include the voxel-based map 235, the output data 245, the voxel-based map of FIG. 8, or a combination thereof.

In some aspects, the depth data includes a point cloud with a plurality of points, and the environment mapping system (or component thereof) is configured to, and can, omit at least one point from the point cloud from the voxel-based three-dimensional map of the environment based on the segmented image data. For instance, the environment mapping system can omit the points corresponding to the false positive 710 from the voxel-based three-dimensional map.

In some aspects, the depth data includes a point cloud with a plurality of points, and the environment mapping system (or component thereof) is configured to, and can, add at least one voxel to the voxel-based three-dimensional map of the environment based on the segmented image data despite a lack of a point in the point cloud corresponding to the at least one voxel. For instance, even though no points exist in the cluster of points 760 for some portions of the building 660, voxels are still marked as corresponding to the building 660 in the cluster of voxels 860 for the entirety of the building 660, even for point-free portions of the building 660. Similarly, if voxel 910 is missing point data, but voxel 905 and voxel 915 include point data for a building or other object type, then the environment mapping system may still indicate that voxel 910 is of the same voxel type as voxel 905 and voxel 915 rather than being free.

In some aspects, the depth data identifies an edge of an object of the different types of objects in the environment, and the environment mapping system (or component thereof) is configured to, and can, add at least one voxel to the voxel-based three-dimensional map of the environment corresponding to a non-edge portion of the object based on the segmented image data despite a lack of representation of the non-edge portion of the object in the depth data. For instance, even though no edge data might exist in the cluster of points 760 for some portions of the building 660, voxels are still marked as corresponding to the building 660 in the cluster of voxels 860 for the entirety of the building 660, even for non-edge portions of the building 660. Similarly, if voxel 910 is missing edge data, but voxel 905 and voxel 915 include edge data for a building or other object type, then the environment mapping system may still indicate that voxel 910 is of the same voxel type as voxel 905 and voxel 915 rather than being free.

In some aspects, the environment mapping system (or component thereof) is configured to, and can, identify a depth of an object in the voxel-based three-dimensional map of the environment based on the depth data, and identify a shape of the object in the voxel-based three-dimensional map of the environment based on the segmented image data. For instance, a shape of the third vehicle 645 (the bicyclist) may be difficult to determine from the cluster of points 745, so the segmented image data 225 may be relied upon for the shape of the third vehicle 645 in the voxel-based three-dimensional map. On the other hand, a depth of the third vehicle 645 (the bicyclist) may be difficult to determine from the segmented image data 225, so the cluster of points 745 may be relied upon for the depth of the third vehicle 645 in the voxel-based three-dimensional map. In some aspects, the environment mapping system (or component thereof) is configured to, and can, identifying color information corresponding to voxels of the voxel-based three-dimensional map of the environment based on colors of corresponding portions of the environment as represented in the image data. The depth data 215 and/or segmented image data 225 can be missing color information, so the environment mapping system can rely on the image data 210 for color information to identify respective colors for the different voxels of the voxel-based three-dimensional map.

In some aspects, the environment mapping system (or component thereof) is configured to, and can, identify respective confidence levels corresponding to the plurality of segments being identified, using the semantic segmentation, as respectively representing the different types of objects. The confidence levels may be output using the trained ML model(s) 260 (e.g., the NN 1000). In some examples, the probability 920 and/or the probability 925 are based on the confidence levels.

In some aspects, the environment mapping system (or component thereof) is configured to, and can, identify, based on the segmented image data, different voxels of the voxel-based three-dimensional map of the environment as representing the different types of objects. In some aspects, the different types of objects in the environment include at least one of ground, sky, plants (e.g., tree 655), structures (e.g., building 660), people (e.g., pedestrian 650, third vehicle 645), and vehicles (e.g., second vehicle 640, third vehicle 645).

In some aspects, the environment mapping system (or component thereof) is configured to, and can, output an indication of the voxel-based three-dimensional map of the environment (e.g., using output device(s) 250, output device 1235, and/or communication interface 1240). In some aspects, the environment mapping system (or component thereof) is configured to, and can, cause display of at least a portion of the voxel-based three-dimensional map of the environment using a display (e.g., output device(s) 250 and/or output device 1235). In some aspects, the environment mapping system (or component thereof) is configured to, and can, cause transmission of at least a portion of the voxel-based three-dimensional map of the environment to a recipient device using a communication interface (e.g., output device(s) 250, output device 1235, and/or communication interface 1240).

In some aspects, the environment mapping system (or component thereof) is configured to, and can, generating a route through the environment for a vehicle based on the voxel-based three-dimensional map of the environment. In some aspects, the environment mapping system (or component thereof) is configured to, and can, modifying movement of a vehicle through the environment based on the voxel-based three-dimensional map of the environment.

In some examples, the environment mapping system includes: means for receiving image data and depth data captured using at least one sensor, the image data and the depth data including respective representations of an environment; means for processing the image data using semantic segmentation to generate segmented image data that identifies a plurality of segments of the environment, wherein the plurality of segments represent different types of objects in the environment; and means for combining the depth data with the segmented image data to generate a voxel-based three-dimensional map of the environment.

The means for receiving the image data and the depth data include at least the image sensor 130, the sensor(s) 205, the first camera 330A, the second camera 330B, the third camera 330C, the fourth camera 330D, the first camera 430A, the second camera 430B, the third camera 430C, the fourth camera 430D, the first camera 530A, the second camera 530B, the third camera 530C, the fourth camera 530D, the fifth camera 530E, the sixth camera 530F, the first sensor 540A, the second sensor 540B, the sensors 625, a sensor used to capture an image and/or depth data used as input data for the input layer 1010 of the NN 1000, the input device 1245, another image sensor described herein, another depth sensor described herein, another sensor described herein, or a combination thereof.

The means for processing the image data and/or for generating the voxel-based three-dimensional map include the image capture and processing system 100, the image processing device 105B, the image processor 150, the ISP 154, the host processor 152, the vehicle 190, the environment mapping system 200, the image processor 220, the fusion processor 230, the output processor 240, the output device(s) 250, the trained ML model(s) 260, the feedback subsystem 265, the HMD 310, the mobile handset 410, the vehicle 510, the first vehicle 605, the vehicle computing device 615, the sensors 625, the neural network 1000, the computing system 1200, the processor 1210, or a combination thereof.

In some examples, the processes described herein (e.g., the respective processes of FIGS. 1, 2, 6, 7, 8, 9, the process 1100 of FIG. 11, and/or other processes described herein) may be performed by a computing device or apparatus. In some examples, the processes described herein can be performed by the image capture and processing system 100, the image capture device 105A, the image processing device 105B, the image processor 150, the ISP 154, the host processor 152, the vehicle 190, the environment mapping system 200, the sensor(s) 205, the image processor 220, the fusion processor 230, the output processor 240, the output device(s) 250, the trained ML model(s) 260, the feedback subsystem 265, the HMD 310, the mobile handset 410, the vehicle 510, the first vehicle 605, the vehicle computing device 615, the sensors 625, the neural network 1000, the environment mapping system that performs the process 1100, the computing system 1200, the processor 1210, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

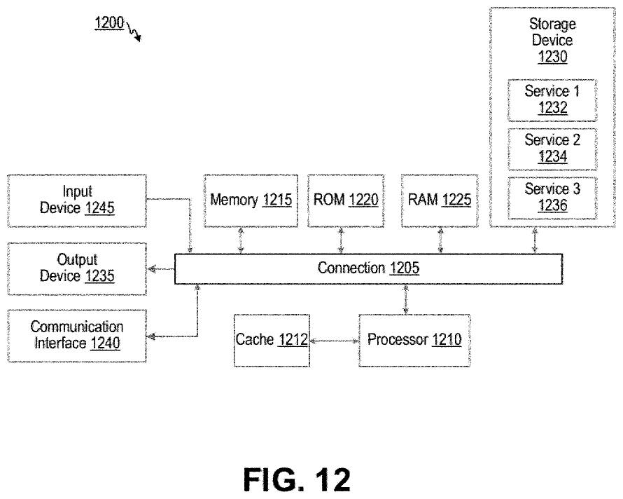

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that couples various system components including system memory 1215, such as read-only memory (ROM) 1220 and random access memory (RAM) 1225 to processor 1210.

Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for environment mapping, the apparatus comprising: a memory; and at least one processor (e.g., implemented in circuitry) coupled to the memory and configured to: receive image data and depth data captured using at least one sensor, the image data and the depth data including respective representations of an environment; process the image data using semantic segmentation to generate segmented image data that identifies a plurality of segments of the environment, wherein the plurality of segments represent different types of objects in the environment; and combine the depth data with the segmented image data to generate a voxel-based three-dimensional map of the environment.

Aspect 2. The apparatus of Aspect 1, wherein the depth data includes a point cloud with a plurality of points, and wherein the at least one processor is configured to omit at least one point from the point cloud from the voxel-based three-dimensional map of the environment based on the segmented image data.

Aspect 3. The apparatus of any of Aspects 1 to 2, wherein the depth data includes a point cloud with a plurality of points, and wherein the at least one processor is configured to add at least in one voxel to the voxel-based three-dimensional map of the environment based on the segmented image data despite a lack of a point in the point cloud corresponding to the at least one voxel.

Aspect 4. The apparatus of any of Aspects 1 to 3, wherein the depth data identifies an edge of an object of the different types of objects in the environment, wherein the at least one processor is configured to add at least one voxel to the voxel-based three-dimensional map of the environment corresponding to a non-edge portion of the object based on the segmented image data 10 despite a lack of representation of the non-edge portion of the object in the depth data.

Aspect 5. The apparatus of any of Aspects 1 to 4, wherein the at least one processor is configured identify a depth of an object in the voxel-based three-dimensional map of the environment based on the depth data, wherein the at least one processor is configured to identify a shape of the object in the voxel-based three-dimensional map of the environment based on the segmented image data.

Aspect 6. The apparatus of any of Aspects 1 to 5, wherein the at least one processor is configured to identify color information corresponding to voxels of the voxel-based three-dimensional map of the environment based on colors of corresponding portions of the environment as represented in the image data.

Aspect 7. The apparatus of any of Aspects 1 to 6, wherein the at least one processor is configured to identify respective confidence levels corresponding to the plurality of segments being identified, as respectively representing the different types of objects.

Aspect 8. The apparatus of any of Aspects 1 to 7, wherein the at least one processor is configured to identify, based on the segmented image data, different voxels of the voxel-based three-dimensional map of the environment as representing the different types of objects.

Aspect 9. The apparatus of any of Aspects 1 to 8, wherein the different types of objects in the environment include at least one of ground, sky, plants, structures, people, and vehicles.

Aspect 10. The apparatus of any of Aspects 1 to 9, wherein the at least one sensor includes an image sensor, wherein the image sensor is configured to capture at least the image data.

Aspect 11. The apparatus of Aspect 10, wherein depth data is based on the image data from the image sensor.

Aspect 12. The apparatus of any of Aspects 1 to 11, wherein the at least one sensor includes a depth sensor, wherein the depth sensor is configured to capture at least the depth data.

Aspect 13. The apparatus of any of Aspects 1 to 12, wherein the at least one processor is configured to output an indication of the voxel-based three-dimensional map of the environment.

Aspect 14. The apparatus of any of Aspects 1 to 13, wherein the at least one processor is configured to cause display of at least a portion of the voxel-based three-dimensional map of the environment using a display.

Aspect 15. The apparatus of any of Aspects 1 to 14, wherein the at least one processor is configured to cause transmission of at least a portion of the voxel-based three-dimensional map of the environment to a recipient device using a communication interface.

Aspect 16. The apparatus of any of Aspects 1 to 15, wherein the at least one processor is configured to generate a route through the environment for a vehicle based on the voxel-based three-dimensional map of the environment.

Aspect 17. The apparatus of any of Aspects 1 to 16, wherein the at least one processor is configured to modify movement of a vehicle through the environment based on the voxel-based three-dimensional map of the environment.

Aspect 18. The apparatus of any of Aspects 1 to 17, wherein the apparatus includes at least one of a head-mounted display (HMD), a mobile handset, or a wireless communication device.

Aspect 19. A method for environment mapping, the method comprising: receiving image data and depth data captured using at least one sensor, the image data and the depth data including respective representations of an environment; processing the image data using semantic segmentation to generate segmented image data that identifies a plurality of segments of the environment, wherein the plurality of segments represent different types of objects in the environment; and combining the depth data with the segmented image data to generate a voxel-based three-dimensional map of the environment.

Aspect 20. The method of Aspect 19, further comprising: omitting at least one point from a point cloud from the voxel-based three-dimensional map of the environment based on the segmented image data, wherein the depth data includes the point cloud with a plurality of points.

Aspect 21. The method of any of Aspects 19 to 20, further comprising: adding at least one voxel to the voxel-based three-dimensional map of the environment based on the segmented image data despite a lack of a point in a point cloud corresponding to the at least one voxel, wherein the depth data includes the point cloud with a plurality of points.

Aspect 22. The method of any of Aspects 19 to 21, further comprising: adding at least one voxel to the voxel-based three-dimensional map of the environment corresponding to a non-edge portion of an object based on the segmented image data despite a lack of representation of the non-edge portion of the object in the depth data, wherein the depth data identifies an edge of the object of the different types of objects in the environment.

Aspect 23. The method of any of Aspects 19 to 22, further comprising: identifying a depth of an object in the voxel-based three-dimensional map of the environment based on the depth data; and identifying a shape of the object in the voxel-based three-dimensional map of the environment based on the segmented image data.

Aspect 24. The method of any of Aspects 19 to 23, further comprising: identifying color information corresponding to voxels of the voxel-based three-dimensional map of the environment based on colors of corresponding portions of the environment as represented in the image data.

Aspect 25. The method of any of Aspects 19 to 24, further comprising: identifying respective confidence levels corresponding to the plurality of segments being identified, as respectively representing the different types of objects.

Aspect 26. The method of any of Aspects 19 to 25, further comprising: identifying, based on the segmented image data, different voxels of the voxel-based three-dimensional map of the environment as representing the different types of objects.

Aspect 27. The method of any of Aspects 19 to 26, wherein the different types of objects in the environment include at least one of ground, sky, plants, structures, people, and vehicles.

Aspect 28. The method of any of Aspects 19 to 27, wherein the at least one sensor includes an image sensor, wherein the image sensor is configured to capture at least the image data.

Aspect 29. The method of Aspect 28, wherein depth data is based on the image data from the image sensor.

Aspect 30. The method of any of Aspects 19 to 29, wherein the at least one sensor includes a depth sensor, wherein the depth sensor is configured to capture at least the depth data.

Aspect 31. The method of any of Aspects 19 to 30, further comprising: outputting an indication of the voxel-based three-dimensional map of the environment.

Aspect 32. The method of any of Aspects 19 to 31, further comprising: causing display of at least a portion of the voxel-based three-dimensional map of the environment using a display.

Aspect 33. The method of any of Aspects 19 to 32, further comprising: causing transmission of at least a portion of the voxel-based three-dimensional map of the environment to a recipient device using a communication interface.

Aspect 34. The method of any of Aspects 19 to 33, further comprising: generating a route through the environment for a vehicle based on the voxel-based three-dimensional map of the environment.

Aspect 35. The method of any of Aspects 19 to 34, further comprising: modifying movement of a vehicle through the environment based on the voxel-based three-dimensional map of the environment.

Aspect 36. The method of any of Aspects 19 to 35, wherein the method is performed using an apparatus that includes at least one of a head-mounted display (HMD), a mobile handset, or a wireless communication device.

Aspect 37. A non-transitory computer-readable medium having stored thereon instructions that, when executed by one or more processors, cause the one or more processors to perform operations according to any of Aspects 1 to 36.

Aspect 38. An apparatus for image processing, the apparatus comprising one or more means for performing operations according to any of Aspects 1 to 36.

1. An apparatus for environment mapping, the apparatus comprising:
at least one memory; and
at least one processor coupled to the at least one memory and configured to:
receive image data and depth data captured using at least one sensor, the image data and the depth data including respective representations of an environment;
process the image data using semantic segmentation to generate segmented image data that identifies a plurality of segments of the environment, wherein the plurality of segments represent different types of objects in the environment; and
combine the depth data with the segmented image data to generate a voxel-based three-dimensional map of the environment.

2. The apparatus of claim 1, wherein the depth data includes a point cloud with a plurality of points, and wherein the at least one processor is configured to omit at least one point from the point cloud from the voxel-based three-dimensional map of the environment based on the segmented image data.

3. The apparatus of claim 1, wherein the depth data includes a point cloud with a plurality of points, and wherein the at least one processor is configured to add at least one voxel to the voxel-based three-dimensional map of the environment based on the segmented image data despite a lack of a point in the point cloud corresponding to the at least one voxel.

4. The apparatus of claim 1, wherein the depth data identifies an edge of an object of the different types of objects in the environment, wherein the at least one processor is configured to add at least one voxel to the voxel-based three-dimensional map of the environment corresponding to a non-edge portion of the object based on the segmented image data despite a lack of representation of the non-edge portion of the object in the depth data.

5. The apparatus of claim 1, wherein the at least one processor is configured identify a depth of an object in the voxel-based three-dimensional map of the environment based on the depth data, wherein the at least one processor is configured to identify a shape of the object in the voxel-based three-dimensional map of the environment based on the segmented image data.

6. The apparatus of claim 1, wherein the at least one processor is configured to identify color information corresponding to voxels of the voxel-based three-dimensional map of the environment based on colors of corresponding portions of the environment as represented in the image data.

7. The apparatus of claim 1, wherein the at least one processor is configured to identify respective confidence levels corresponding to the plurality of segments being identified, using the semantic segmentation, as respectively representing the different types of objects.

8. The apparatus of claim 1, wherein the at least one processor is configured to identify, based on the segmented image data, different voxels of the voxel-based three-dimensional map of the environment as representing the different types of objects.

9. The apparatus of claim 1, wherein the different types of objects in the environment include at least one of ground, sky, plants, structures, people, and vehicles.

10. The apparatus of claim 1, wherein the at least one sensor includes an image sensor, wherein the image sensor is configured to capture at least the image data.

11. The apparatus of claim 10, wherein the depth data is based on the image data from the image sensor.

12. The apparatus of claim 1, wherein the at least one sensor includes a depth sensor, wherein the depth sensor is configured to capture at least the depth data.

13. The apparatus of claim 1, wherein the at least one processor is configured to output an indication of the voxel-based three-dimensional map of the environment.

14. The apparatus of claim 1, wherein the at least one processor is configured to cause display of at least a portion of the voxel-based three-dimensional map of the environment using a display.

15. The apparatus of claim 1, wherein the at least one processor is configured to cause transmission of at least a portion of the voxel-based three-dimensional map of the environment to a recipient device using a communication interface.

16. The apparatus of claim 1, wherein the at least one processor is configured to generate a route through the environment for a vehicle based on the voxel-based three-dimensional map of the environment.

17. The apparatus of claim 1, wherein the at least one processor is configured to modify movement of a vehicle through the environment based on the voxel-based three-dimensional map of the environment.

18. The apparatus of claim 1, wherein the apparatus includes at least one of a head-mounted display (HMD), a mobile handset, or a wireless communication device.

19. A method for environment mapping, the method comprising:
receiving image data and depth data captured using at least one sensor, the image data and the depth data including respective representations of an environment;
processing the image data using semantic segmentation to generate segmented image data that identifies a plurality of segments of the environment, wherein the plurality of segments represent different types of objects in the environment; and
combining the depth data with the segmented image data to generate a voxel-based three-dimensional map of the environment.

20. (canceled)

21. (canceled)

22. (canceled)

23. (canceled)

24. (canceled)

25. (canceled)

26. The method of claim 19, further comprising:
identifying, based on the segmented image data, different voxels of the voxel-based three-dimensional map of the environment as representing the different types of objects.

27. (canceled)

28. (canceled)

29. (canceled)

30. (canceled)
